(19) United States
(12) Patent Application Publication
(10) Pub. No.: US 2016/0007585 A1
(43) Pub. Date: Jan. 14, 2016

(54) INSECT CONTROL DEVICE

(71) Applicants: Basilio Ngari Njiru, Nyanza (KE); Clarke Mosquito Control Products, Inc., St. Charles, IL (US); Ohio State Innovation Foundation, Columbus, OH (US)

(72) Inventors: William Jany, St. Charles, IL (US); John Milliner, McCall, ID (US); Edward D. Walker, East Lansing, MI (US); Woodbridge A. Foster, Columbus, OH (US); Don Alexander, Barnwell, SC (US); Daniel Alexander, Barnwell, SC (US); Babak Ebrahimi, Columbus, OH (US); Basilio Ngari Njiru, Nyanza (KE)

(21) Appl. No.: 14/793,700

(22) Filed: Jul. 7, 2015

Related U.S. Application Data
(60) Provisional application No. 62/022,180, filed on Jul. 8, 2014.
(60) Provisional application No. 62/083,294, filed on Nov. 23, 2014.
(60) Provisional application No. 62/137,534, filed on Mar. 24, 2015.

(51) Int. Cl. A01M 1/20; A01N 43/22; A01M 1/10

(52) U.S. Cl. CPC A01M 1/2016; A01M 1/106; A01N 43/22

(57) ABSTRACT

A bait station comprising a housing that comprises a flexible portion; a composition contained on or in the housing and comprising at least one sugar and at least one toxin; an insert coupled to the housing; and at least one olfactory attractant contained in the insert.

### CROSS-REFERENCE TO RELATED APPLICATIONS

This application claims priority to U.S. Provisional Application No. 62/022,180, filed Jul. 8, 2014, U.S. Provisional Application No. 62/083,294, filed on Nov. 23, 2014, and U.S. Provisional Application No. 62/137,534, filed on Mar. 24, 2015, the entire contents of each of foregoing patent applications being incorporated herein by reference.

### BACKGROUND

The present invention relates to devices and methods to control insects, in particular, a bait station and its use for insect control.

### SUMMARY

In some embodiments, the invention provides a bait station comprising a housing that comprises a flexible portion. A composition is contained on or in the housing and comprises at least one sugar and at least one toxin. An insert is coupled to the housing and at least one olfactory attractant is contained in the insert.

In other embodiments, the invention provides a composition comprising at least one sugar and at least one toxin. The sugar is selected from the group consisting of sucrose, glucose, fructose, galactose, dextrose, and lactose. The toxin is selected from the group consisting of spinosad, neonicotinoid, carbamate, organophosphate, organochlorine, pyrethrum, pyrethrin, pyrethroid, chlofenapyr, ethiprole, sulfoxoflor, pyriproxyfen, and boric acid.

In at least one embodiment, the invention provides a composition comprising by weight 8%-15% sucrose, 0.003%-1.0% spinosad, 0.0625%-0.5% linalool, 0.0938%-0.75% 1-hexanol, and 0.2188%-1.75% phenylacetaldehyde.

In at least one embodiment, the invention provides a method for manufacturing a bait station that comprises providing a housing that comprises a flexible portion and applying a composition to the housing. The composition comprises at least one sugar and at least one toxin. The method further comprises providing an insert, placing at least one olfactory attractant in the insert, and coupling the insert to the housing.

In at least one embodiment, the invention provides a method for controlling insects that comprises applying an effective amount of the composition of at least one of claims 21-35 to a bait station, and exposing a population to the bait station.

### BRIEF DESCRIPTION OF THE DRAWINGS

FIG. 1 is a perspective view of a bait station according to one embodiment of the invention.

FIG. 2 is a perspective view of a bait station according to a second embodiment of the invention.

FIG. 3 is a perspective view of a bait station according to a third embodiment of the invention.

FIG. 4 is a perspective view of a bait station according to a fourth embodiment of the invention.

FIG. 5 is a perspective view of a bait station according to a fifth embodiment of the invention.

FIG. 6 is a cross-sectional view of the bait station of FIG. 5 along line 6-6 of FIG. 5.

FIG. 7 is a perspective view of the bait station of FIG. 5 in a folded or collapsed configuration.

FIG. 8 is perspective view of the bait station of FIG. 5 with a portion of a housing cutaway.

FIG. 9 is a perspective view of a bait station according to a sixth embodiment of the invention.

FIG. 10 is a perspective view of a bait station according to a seventh embodiment of the invention.

FIG. 11 is a perspective view of an enclosure to be used with an embodiment of the invention, including one of the bait stations of FIGS. 1-10 and 15-16.

FIG. 12 is a perspective view of the enclosure of FIG. 11 stacked on a second enclosure.

FIG. 13 is an exploded view showing an insert that can be included in various embodiments including those illustrated in FIGS. 1-10 and 15-16.

FIG. 14 is a top view of the insert of FIG. 13.

FIG. 15 is a view of the insert of FIG. 13 with a corner folded over to show two sides of the insert.

FIG. 16 is a side view of a bait station according to an eighth embodiment of the invention.

FIG. 17 is a side view of a bait station according to a ninth embodiment of the invention.

FIG. 18 is a view of the test-set up of Example 1.

FIG. 19a shows representative release profiles of hexanol suspended in hexane or mineral oil and applied to nylon sock or cotton wick.

FIG. 19b shows representative release profiles of phenylacetaldehyde suspended in hexane or mineral oil and applied to nylon sock or cotton wick.

FIG. 20 shows percent survival of Anopheles gambiae females provided with dry surface or moist surface fabrics soaked with 10% sucrose solution.

### DETAILED DESCRIPTION

Before any embodiments of the invention are explained in detail, it is to be understood that the invention is not limited in its application to the details of construction and the arrangement of components set forth in the following description or illustrated in the figures. The invention is capable of other embodiments and of being practiced or of being carried out in various ways.

Devices and Methods

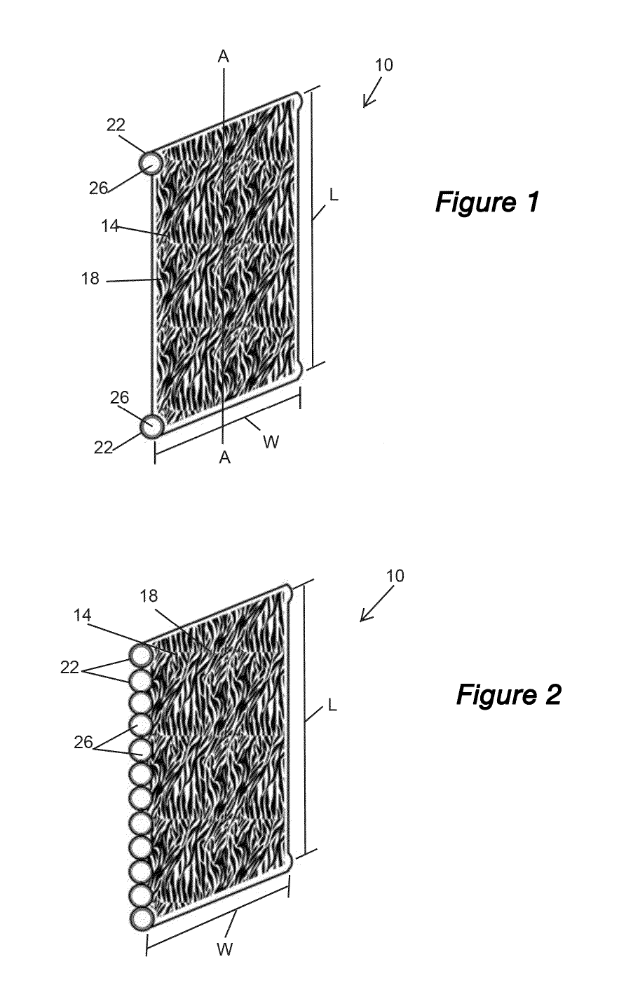

FIG. 1 illustrates an insect control device or bait station 10 that includes a double-sided panel 14 defining a longitudinal axis A, a width W, and a length L. The panel 14 is constructed from a fabric that is configured to receive and to retain a solution that incorporates a mixture of one or more sugars and one or more toxins (hereinafter “sugar/toxin solution”). The panel may include a single layer of fabric or may include at least two layers of fabric stacked relative to one another.

The panel 14 provides a substantial surface area and may be constructed from one more layers of fabric made up of any suitable natural or synthetic fibers. The panel 14 may be flexible, rigid, or have portions that are flexible and portions that are rigid. For example, the fabric may be constructed from materials such as, among others, jute, natural waxes, pectin, sugars, cellulose, protein, or organic polymers, such that the resulting fabric absorbs and retains the sugars/toxin solution and is capable of displaying a visual image or pattern. The panel 14 may also contain natural cotton, linen, flax, wool, or any combination thereof. The fabric is constructed to be strong and durable and, therefore, resilient to withstand inclement or harsh environmental conditions for, in some embodiments, at least six months at a time. In addition to the sugar/toxin solution, which will be discussed in greater detail below, the fabric may also include substances that prevent biological degradation through preservative antimicrobial, anti-fungal, and/or anti-mold products. Additionally, the fabric may include protection against ultraviolet (UV) radiation.

The sugar/toxin solution may be applied to the bait station 10 in any suitable way. For example, the solution may be sprayed onto the fabric, or alternatively, the fabric may be soaked in or impregnated with the solution. Once applied, the fabric dries such that the solution becomes embedded into the fabric. In other embodiments, the solution is applied (e.g., sprayed onto) the panel 14, and the panel 14 is kept slightly damp or moist. For example, in some embodiments, the solution is reapplied to the panel 14 at regular intervals such that the panel 14 is also more damp, and therefore, appealing to insects. Additionally, the housing panel 14 can include a wetting agent or mechanism to keep the panels 14 damp, which will be described in greater detail below.

Alternatively, the solution may be dried or embedded into the fabric of the panel 14, and the panel 14 kept moist using additional solution or any suitable moistening solution. For example, the fabric of the panel 14 is treated using an immersion and padding application process. In particular, the fabric can be submerged in the liquid solution of a chemical, which will be described in greater detail below, until the fabric has absorbed as much liquid as possible. Excess liquid is then removed from the fabric using a textile application process known as padding. Excess liquid is returned to the applicator to reduce waste. The padding process produces uniformly treated materials that are consistent within and between devices. Typically, the treated devices can be tumble dried.

Certain embodiments disclosed herein use the concept that mosquitoes will actually feed on a surface that contains sugar even if that surface is dry. The disclosed data establishes this dry feeding behavior. For example, the fabrics of the present device can be dried after being impregnated with the sugar/toxin solution. Such a device can be used to control mosquitoes in a dry or humid environment, or an environment without any source of water.

In other embodiments disclosed herein, the bait station includes a wetting agent or mechanism (such as an insert), which provides a way to capture moisture proximate to the bait station to enhance its effectiveness because mosquitoes are more likely to feed in areas with higher local moisture. The embodiments accomplish this by integrating silicon beads or a superabsorbent material into the fabric of the bait station. In some embodiments, the present device can be constructed with dry fabric surfaces impregnated with the sugar/toxin solution and shipped to a location where insect control is needed. At such location, the present device either can be used with the dry fabric surface (i.e., no further construction or processing is needed) or can be used after the surface is dampened or moistened.

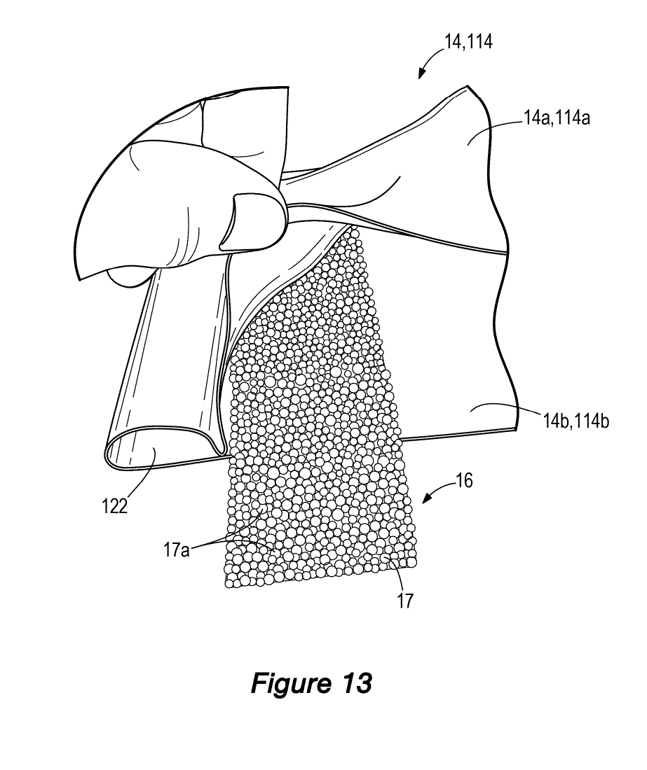

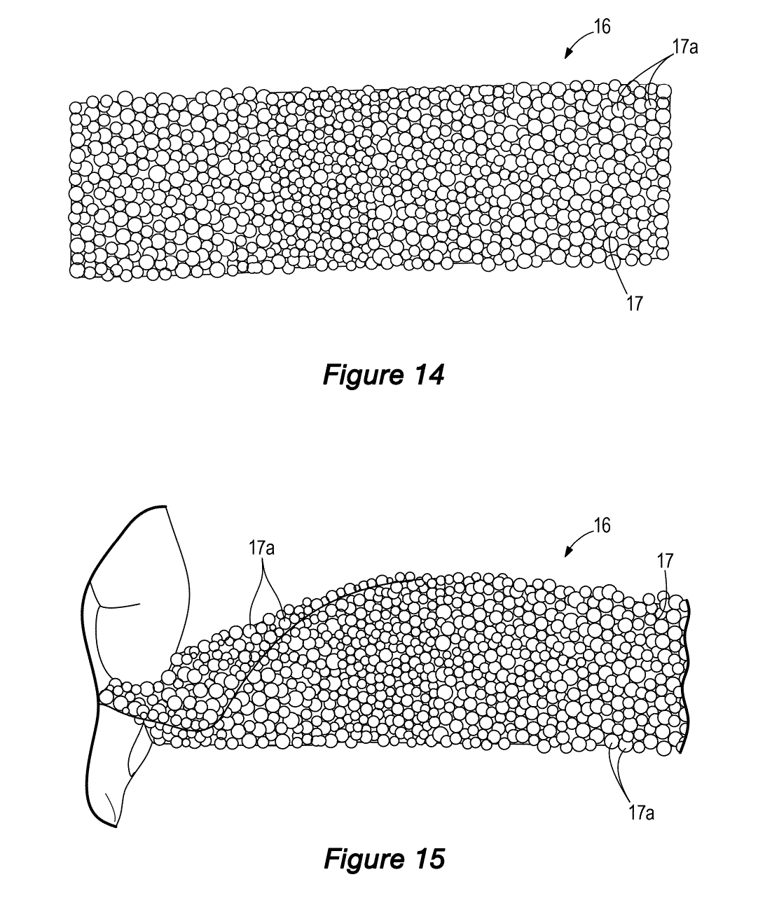

In several embodiments, the dried fabric that results from the immersion and padding application process may also be used with an insert or high moisture insert 16 (FIGS. 13-15) configured to create an area of moisture within, or in close proximity to, the bait station 10. For example, the insert 16 may be constructed from a thin strip 17 containing a uniform layer of silica beads 17a. The silica beads 17a adsorb and concentrate moisture and are therefore used to distribute moisture over a large surface area with relatively low quantities of silica beads. Suitably, the silica beads 17 absorb approximately 20%-40% of their weight in moisture from the atmosphere. As illustrated in FIG. 13, the insert 16 may be positioned between the adjacent fabric layers 14a, 14b of the panel 14 to capture moisture from humidity and concentrate the moisture behind an exterior surface of the panel 14. Accordingly, the silica beads 17a of the insert 16 are used to increase moisture in and around the bait station 10, the significance of which will be described in greater detail below. In other embodiments, a superabsorbent material can be included in the insert in addition to or as an alternative to silica beads. Suitable superabsorbent materials include superabsorbent polymers (SAPs) that can absorb and retain moisture at least about 0.5 time, 1 time, 10 times, 50 times, 100 times, or even 400 times their weight. Suitable superabsorbent polymers include hydrogel-forming polymers, such as natural, modified natural, and synthetic hydrogel-forming polymers. Natural hydrogel-forming polymers include, but are not limited to, agar, pectin, and guar gum. Modified natural polymers include, but are not limited to, carboxymethyl cellulose, carboxyethyl cellulose, and hydroxypropyl cellulose. Examples of synthetic hydrogel-forming polymers include, but are not limited to, polyacrylates, polyacrylamides, polyvinyl alcohol, polyvinyl pyridine, and the like. Other types of known superabsorbent polymers may also be used for the present technology. The superabsorbent material can be included in the insert in various forms, such as granules.

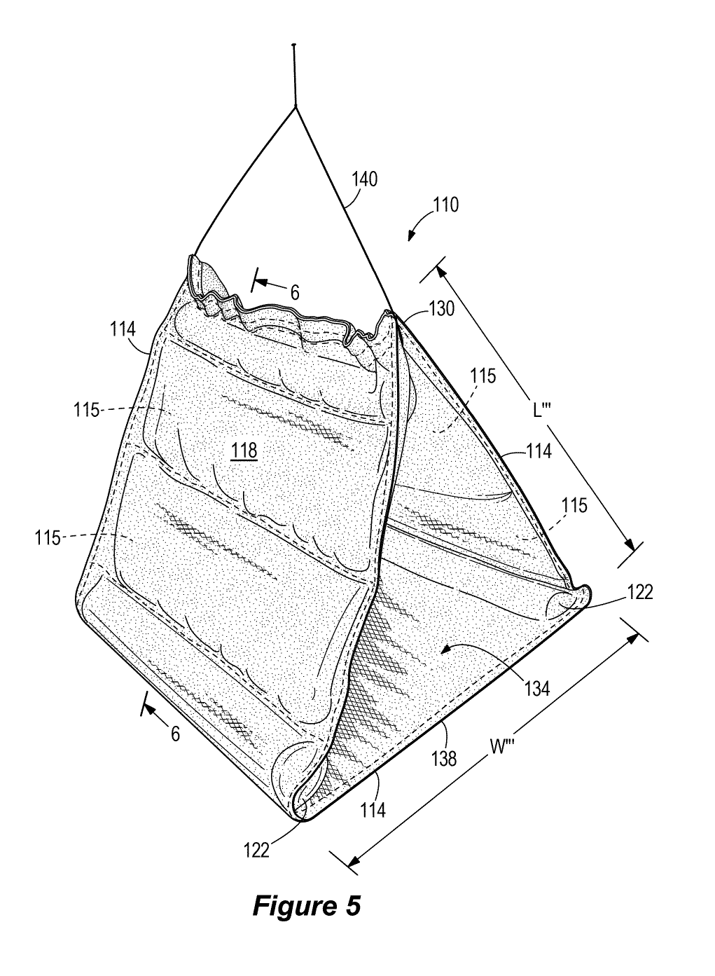

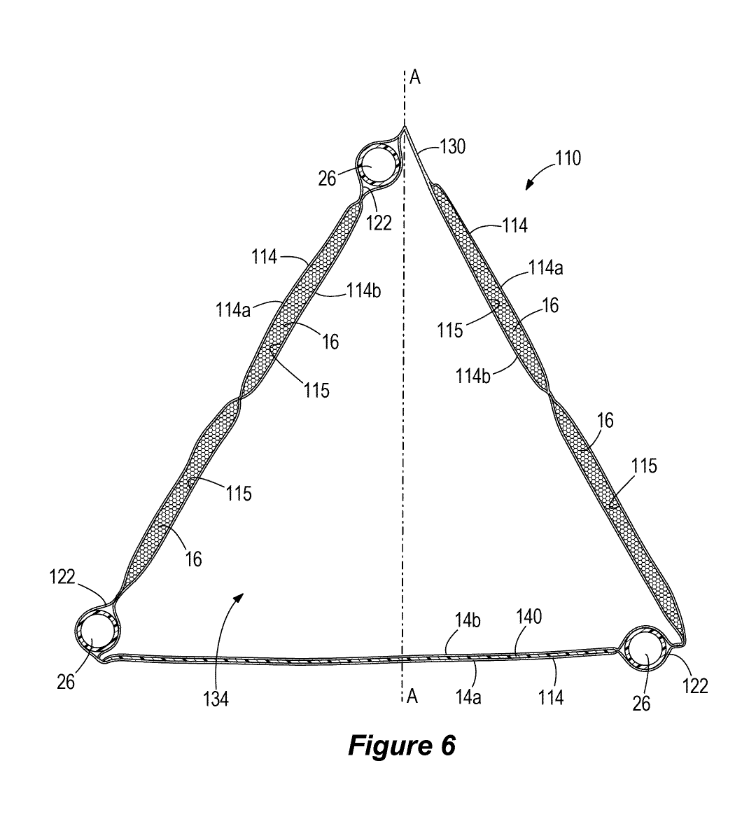

Further with respect to FIG. 1, at least one of the first or the second sides of the panel 14 may include a visual attractant (e.g., color, design, pattern, image, or any combination thereof) 18. The visual attractant 18 may be printed onto the exterior surface of the panel 14. Alternatively, the visual attractant 18 may be formed with the fabric by using colors and patterns that are different than the surrounding portion of the panel 14 to create the design. The visual attractant 18 is advantageous because the bait station 10 can be customized to the specific region in which the bait station will be employed. For example, the visual attractant 18 of each bait station 10 can be configured to mimic plants or other features of a specific area or that particularly attract a particular type of insect. One or more fluorescent dyes, several visible dyes, UV lights and/or light-test monofilament line may also be implemented to create the visual attractant 18. The visual attractant 18 may also be any suitable color. For example, FIGS. 5-8 illustrate bait stations 110 that include fabric of only one color, such as black. Accordingly, the color of the fabric is the visual attractant, and therefore, the entire side of each panel is the visual attractant. The bait stations 110 of FIGS. 5-8 will be described in greater detail below. Alternative embodiments do not include a visual attractant.

The panel 14 also may include one or more conduits or channels 22. In the embodiment illustrated in FIG. 1, the bait station 10 includes first and second conduits 22 that extend along the width W of the panel 14 at opposite ends thereof. The conduits 22 can be oriented perpendicular, parallel, or at an oblique angle to the longitudinal axis A in FIG. 1. In additional or alternative embodiments, the panel may include greater or fewer conduits 22. For example, FIG. 2 illustrates twelve conduits 22 stacked relative to one another along the length L of the panel 14. Each of the conduits 22 extends along the width W of the panel 14 in FIG. 2. In additional or alternative embodiments, the conduits 22 may extend along the length L or along both the width W and the length L.

Further with respect to FIGS. 1 and 2, each of the conduits 22 are configured to removably secure an elongate tube 26 that receives an olfactory attractant. To the extent different insects and insects of different regions are each attracted to specific scents or ranges of scents, the ability to substitute different scents or combinations of scents quickly and conveniently is advantageous. Therefore, the tube 26 can include any suitable olfactory attractant. For example, the tube 26 may be filled with a fiberfill saturated with mineral oil having a specific scent, although the olfactory attractant may be received in the tube 26 using any suitable combination of materials. Alternatively, the olfactory attractant may be incorporated into a gel, or any slow release material, that blends three chemicals attractive to An. gambiae. In one specific embodiment, the gel may contain linalool, 1-hexanol, and phenylacetaldehyde in a ratio of 2:3:7 with a 0.6% wt/wt loading of the attractant blend into the gel. The chemicals listed herein are merely exemplary, however, as any suitable chemicals in any combination may be used to create appropriate olfactory attractants, as is discussed in greater detail below.

The tube 26 provides a reservoir that has a small evaporative surface such that the tube 26 delivers the olfactory attractant to opposite ends of the tube 26 and/or along the length of the tube 26. The use of the tube 26 to house the olfactory attractant reduces point source emission of attractant and allows for distribution of attractant or release along the length of the tube 26 and/or release of attractant at each end of the tube 26. In some embodiments, the reservoir provided by the tube 26 ensures a slow release and stability of the attractant or attractants contained therein for a target of at least six months. The tube 26 may be refillable and, therefore, reusable. Alternatively, the tube 26 may be disposable once the olfactory attractant has substantially evaporated. Additionally, the bait station 10 may employ one or more than one olfactory attractant. In other words, each conduit 22 may house a tube 26 having the same or different olfactory attractants. This feature is especially advantageous. For example, mixtures of attractants are sometimes more effective than individual attractants. Direct mixing of attractants can often result, however, in chemical reactions that may form undesirable isomers or derivatives. Therefore, having more than two or more attractants available and unmixed is beneficial.

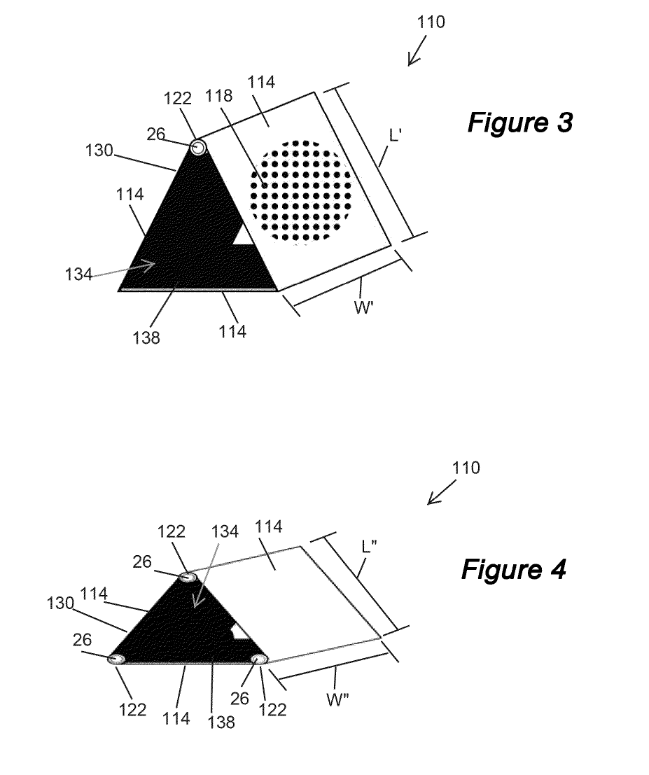

FIGS. 3-10 illustrate alternative embodiments of bait stations employing similar features as discussed above with respect to FIGS. 1 and 2.

FIGS. 3-8 illustrate polygonal bait stations 110 that include at least three double-sided panels 114. Like the panels 14 of FIGS. 1 and 2, the panels 114 are constructed from a fabric that is configured to receive and retain the sugar/toxin solution. The solution and the application methods thereof described above with respect to FIGS. 1 and 2 also apply to the bait stations 110 of FIGS. 3-8 and are therefore not repeated. The panels 114 are coupled to one another to form a housing 130 that defines an opening 134 that extends through the bait station. In the embodiments of FIGS. 3-8, the bait stations 110 have triangular housings (that is, three-sided housing) and, therefore, include three panels 114. In the embodiment of FIG. 3, a width W′ and a length L′ of each the panels 114 are equal. In contrast, in the embodiment illustrated in FIG. 4, a width W″ and a length L″ of each of the panels 114 are not equal. Rather, the length L″ is greater than the width W″ such that the housing 130 is longer than it is tall. As should be apparent by at least FIGS. 3-8, the panels 114 may have any suitable width and length. In additional or alternative embodiments, the bait station 110 may have more panels 114 such that the housing has alternative shapes (for example a four-sided housing, a five-sided housing, a six-sided housing, a seven-sided housing, or an eight-sided housing).

The housing 130 is configured such that the opening 134 extending through the housing provides an area that avoids light, including interior artificial lighting or sunlight. At least one of the panels 114 may include a visual attractant 118, as discussed in detail above with respect to FIGS. 1 and 2. For example, either an interior of the housing 130 or an exterior of the housing 130 or both may be configured to offer a landing surface 138 that is darker and cooler than the area surrounding the bait station 110. In other words and as discussed in greater detail in the examples that follow, dark colors, such as the color black attracts insects such as mosquitoes. To this end, an interior surface created by the panels 114 may be darker in color than exterior surfaces of the same. Alternatively, the entire bait station 110 (FIGS. 5-8) may be a visual attractant by including only black surfaces. This may be accomplished by using the same or different fabrics on each of the sides of the panels 114. The visual attractant 118 may also be a pattern (e.g., the patterns disclosed in FIGS. 1-3 and 5-6) that is formed on one or more of the panels 114.

Further with respect to FIGS. 3-8, at least one conduit 122 may extend between adjacent panels 114. In the embodiments of FIG. 3, only one conduit 122 is coupled between two adjacent panels 114 such that there is only one corner of the housing 130 that includes a conduit 122. Alternatively, FIG. 4 includes three conduits 122 that are each coupled between adjacent panels 114 such that there is a conduit 122 in each corner of the housing 130. Another alternative embodiment is shown in FIGS. 5-8, which has one panel that has two conduits 122 positioned adjacent a first and a second corner of the housing 130, and another of the panels includes a third conduit 122 adjacent a third corner of the housing 130. The bait station 110 may include more or fewer conduits 122. For example, if the bait station includes a four-sided housing, there could be a conduit in each corner or in opposite corners or in only one corner. Additionally, the conduits 122 may not necessarily be positioned between adjacent panels 114, but may be positioned elsewhere, for example, in the middle of the panels. Like the conduits 22 discussed above with respect to FIGS. 1 and 2, the conduits 122 are configured to removably receive and secure tubes 26 therein, as discussed in detail above. In FIGS. 3-8, when received in the conduits 22, the tubes 26 also help to evenly distribute weight of the housing 130 and also impart strength and form to the housing 130.

Further with respect to FIGS. 3-8, the bait station 110 of FIGS. 3 and 4 are shown as panels 114 having a single layer of fabric, while the bait station of FIGS. 5-8 is shown as having two layers of fabric. More specifically, at least one of the panels 114 of the bait station of FIGS. 5-8, like FIG. 13 described above, each have at least one of the inserts 16 positioned between the layers 114a, 114b of fabric. In the illustrated embodiment, two of the panels 114 each include two inserts that are positioned between layers 114a, 114b of fabric. Each insert is secured within a pouch 115 to maintain its vertical position relative to the length L′″ of the panel 114. Also, one of the panels 114 includes a rigid or stiffening member 140 positioned between layers 114a, 114b of fabric to provide a more supportive landing surface. It should be understood that the embodiment of FIGS. 3 and 4 may include panels 14 having two layers of fabric rather than a single layer and may also include panels 114 having one or more inserts 16 or a panel having the stiffening member 140. Similarly, FIGS. 3-8 may include panels having a single layer of fabric rather than two layers of fabric. Regardless of the construction, at least one of the panels 114 of the housing 130 is flexible.

Further with respect to FIGS. 5-8, the two layers 114a, 114b of fabric of each panel 114 are secured (that is, sewn, bolted, or adhered) to one another along peripheral edges thereof. Accordingly, the three adjacent panels may be formed as a single, foldable piece that can be manipulated and secured into the triangular housing 130 by coupling (that is, sewn, bolted, or adhered) the two outer panels to one another.

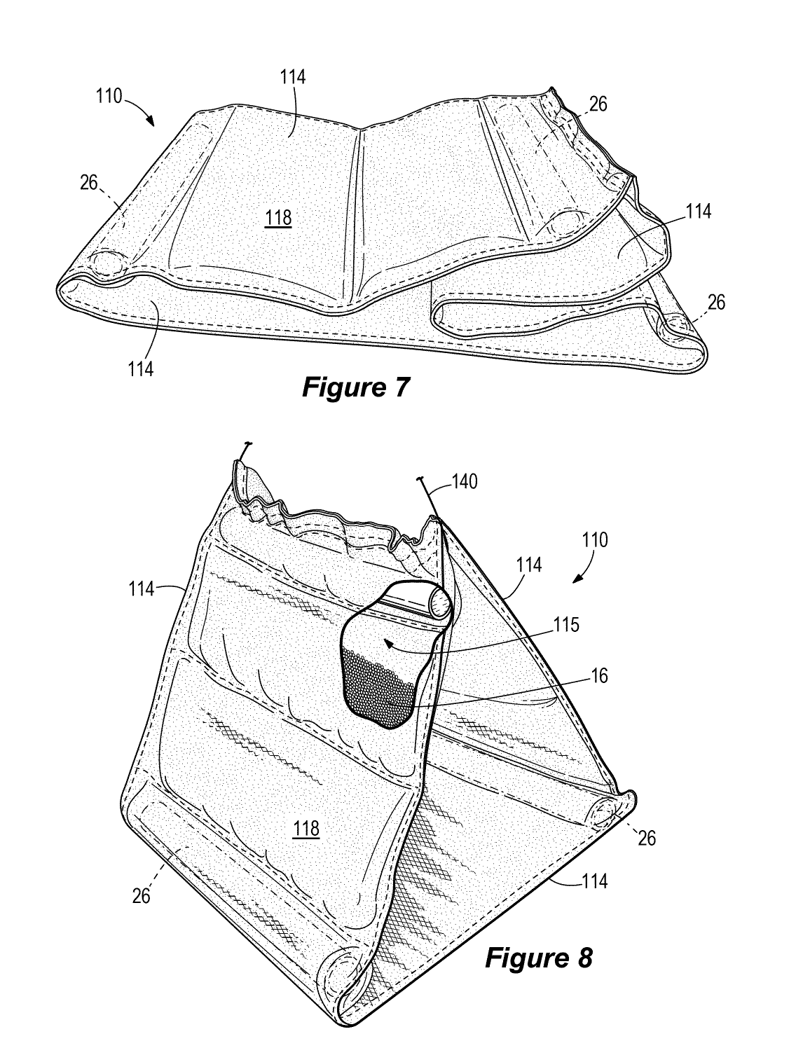

Further with respect to FIGS. 5-8, the bait station 110 is capable of assuming at least two configurations: a first, expanded configuration (FIGS. 5, 6, and 8) in which the housing 130 functions to attract and kill insects and a second, folded configuration (FIG. 7) in which the housing 130 is flattened or otherwise takes up less space than the first configuration. For example, the panels 114 are collapsible relative to one another to reduce the size of the bait station for storage and/or transport. The bait station 110 easily and automatically expands when suspended during use. Although only specifically illustrated and discussed relative to the embodiment of FIGS. 5-8, it should be understood that each of the embodiments illustrated and described herein has a first, expanded configuration and a second, folded configuration.

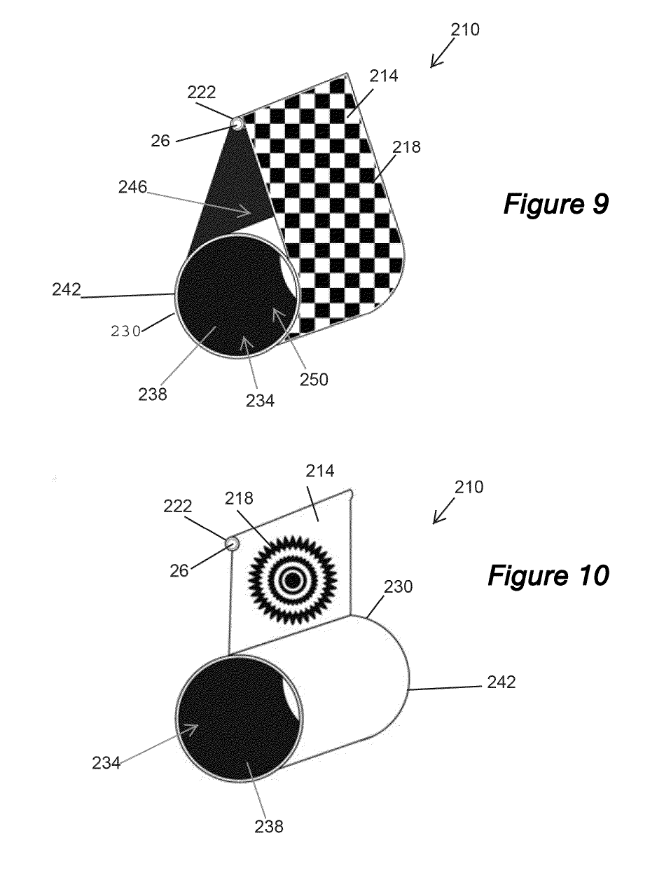

FIGS. 9 and 10 illustrate bait stations 210 that have alternative housing embodiments. In FIG. 9, opposite ends of a double sided panel 214 form a substantially tear-drop shaped housing 230. The panel 214 is constructed from a fabric that is configured to receive and retain a solution that incorporates the sugar/toxin solution. The solution and the application methods thereof described above with respect to FIGS. 1 and 2 also apply to the bait stations 210 of FIGS. 9 and 10 and are therefore not repeated. The housing 230 defines an opening 234 that extends through the housing. A substantially cylindrical member 242 extends through the opening 234 and may be coupled to an interior surface of the panel 214 (e.g., by an adhesive material or by being sewn to the panel 214). The member 242 can also be constructed from a fabric that is configured to receive and retain the sugar/toxin solution. Alternatively, the member 242 can be constructed from cardboard, paperboard, or corrugated fiberboard, among other suitable materials. It is preferred that the member 242 be constructed from a material that imparts rigidity or stiffness to the housing 230, which is otherwise substantially flexible. The member 242 imparts durability to the housing 230. In the embodiment of FIG. 9, the member 242 separates the opening 234 of the bait station 210 into two compartments 246, 250. In alternative embodiments, the member 242 can be of any suitable shape, including triangular, cuboidal, or rectangular.

The housing 230 is configured such that the opening 234 extending through the housing provides an area that avoids light, including interior light and light from the sun. At least one of the panels 214 may include a visual attractant 218, as discussed in detail above with respect to FIGS. 1-8. For example, either an interior of the housing 230 or an exterior of the housing 230 or both may be configured to offer a landing surface 238 that is darker and cooler than the area surrounding the bait station 210. In other words and as discussed in greater detail in the examples that follow, the dark colors such as the color black attracts insects such as mosquitoes. To this end, an interior surface created by the panels 214 may be darker in color than exterior surfaces of the same. Alternatively, the entire bait station 210 may be a visual attractant by including only black surfaces, similar to FIGS. 5-8. This may be accomplished by using the same or different fabrics on each of the sides of the panels 214. The visual attractant 218 may also be a pattern (e.g., patterns disclosed in FIGS. 1-3 and 9-10) that is formed on one or more of the panels 214.

Further with respect to FIG. 9, at least one conduit 222 extends between adjacent ends of panel 214. In the embodiment of FIG. 9, the bait station 210 only includes one conduit 222. In alternative or additional embodiments, however, the bait stations 210 may include more or fewer conduits 222 that may be positioned elsewhere in the bait station 210. Like the conduits 22, 122 of the other embodiments discussed above, the conduits 222 are configured to removably receive and secure tubes 26 in the conduit.

In the embodiment of FIG. 10, the panel 214 is planar and coupled to a surface of the member 242. At least one of the first or the second sides of the panel 214 includes a visual attractant 218 as discussed above with respect to the other embodiments.

In use, the bait stations 10, 110, 210 of FIGS. 1-8 may be suspended or hung from a support structure (not shown) such that both sides of the panels 14, 114, 214 are accessible to insects. Preferably, the bait stations 10, 110, 210 are suspended by a monofilament line 140 (shown for example in FIGS. 5 and 8) that is secured to at least one of the panels 14, 114, 214. In particular, the monofilament line is preferably threaded through a washer that includes a deterring material, which prevent ants from reaching the bait station. For example, the deterring material may be petroleum jelly. The monofilament line 140 or the deterring material or both may also include a repellent to kill ants and other pests. Alternatively, the monofilament line 140 a repellent such as a pyrethroid impregnated to control ants and other pests. The monofilament line 140 may be impregnated with the repellent by known processes, although the repellent may be included in the monofilament line 140 by any other suitable process. Additionally, the bait stations may rest on a support surface (e.g., a table, ledge, or floor).

When the bait stations 10, 110, and 210 are in use, the olfactory attractant contained in the tubes 26 and optionally the visual attractants 18, 118, 218 entice the insects to land on the panel 14 or in the opening 134, 234 of the housing 130, 230, which includes the sugar/toxin solution. The insects draw sugar from the panels 14, 114, or 214 and, in doing so, ingest any toxins that are incorporated in the solution. The toxins terminate the insects thereby preventing them from afflicting the native population.

As discussed above, the bait stations 10, 110, 210 discussed herein are easy to ship and assemble. Because the bait stations 10, 110, 210 are constructed from fabric, they may be folded and substantially flattened such that they may be shipped in bulk. The tubes 26 may be shipped together with or separately from the bait stations 10, 110, or 210. Once on site, the bait stations 10, 110, and 210 may be assembled by inserting the tubes into the conduits 22, 122, or 222 and suspended or placed appropriately.

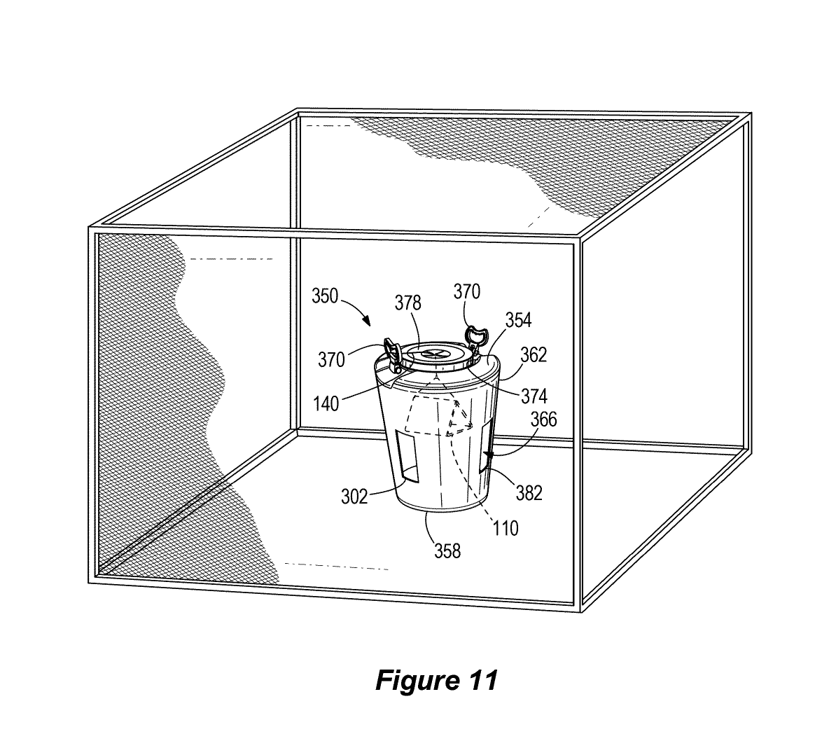

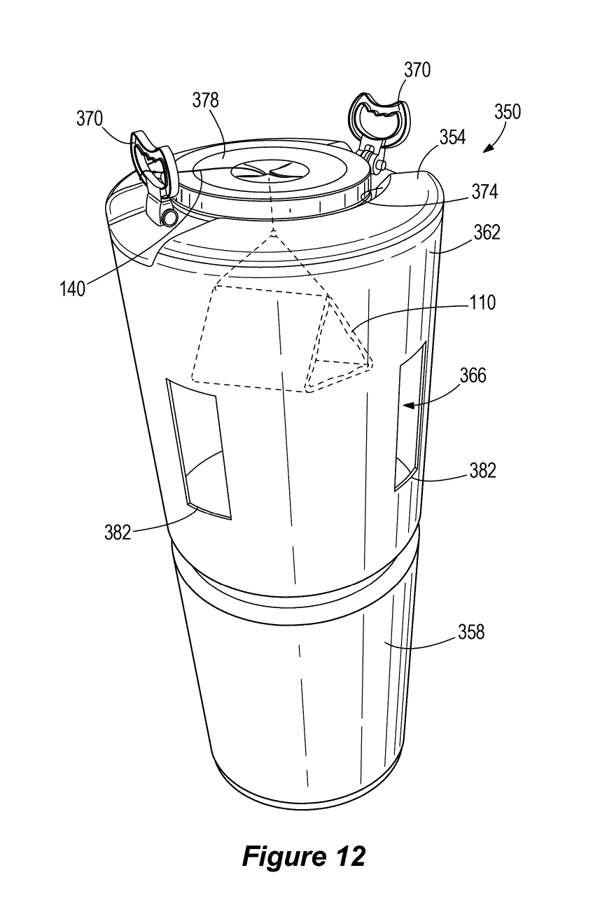

Although not necessary for use with the bait stations 10, 110, 210, FIGS. 11 and 12 illustrate a drum or enclosure 350 that is configured to be used with the bait stations 10, 110, 210 and contributes to attracting mosquitos when used with the bait stations 10, 110, 210. In the illustrated embodiment, the drum 350 is a 50 L black, plastic drum having a 39 cm diameter and a 50 cm height. But any size and shape that may be functional to enclose the bait stations 10, 110, 210 may be used. Further, the enclosure 350 may be composed of another functional material that is not plastic.

The drum 350 is generally cylindrical in shape and includes a top 354, a bottom 358 spaced from the top by a height H, a side 362 extending from the top 354 to the bottom 358, and a cavity 366 defined within. As illustrated in FIGS. 11 and 12, the top 354 and the bottom 358 are circular in shape and have generally identical diameters D. The top 354 and the bottom 358 may have, however, any suitable shape and size. The top 354 includes two handles 370 and a circular hole 374 in which a tight fitting, screw-in-place member 378 is inserted. The handles 370 and screw-in-place member 378 are optional. The side 362 includes a plurality of openings 382 configured to provide the insects access to the cavity 366.

As illustrated in FIGS. 11 and 12, the openings 382 are generally rectangular and have a height that is larger than their widths. In the illustrated embodiment, each of the drums 350 includes three openings 382 positioned equidistant about the drum 350 (i.e., each opening 382 is spaced 120° from an adjacent opening 382 about the side 362) and all are positioned at substantially the same height on the drum 350. In other embodiments, the drums 350 may have more or fewer openings 382 positioned about the side 362 in any suitable manner. The openings 382 may also be positioned substantially perpendicular to the openings 382 illustrated in FIG. 12 (i.e., having a width greater than their height). In this embodiment, the openings 382 may be positioned at different heights on the drum and appear almost stacked relative to one another.

The drum 350 is oriented in relation to the bait stations 10, 110, 210 so that the longitudinal axis of the drum is perpendicular, parallel, or at an oblique angle to the longitudinal axis A in FIG. 1. FIGS. 11 and 12 illustrate a longitudinal axis of the drum positioned along the longitudinal axis A. The bait stations 10, 110, 210 are positioned in the cavity 366 of the enclosure 350 and are suspended or hung from the top 354 of the enclosure 350, as similarly described above as being hung from the support structure. In the illustrated embodiment, the monofilament line is strung to both the handles 370 and sent through the hole 374 in the top 354 so that the bait stations 10, 110, 210 hang or are suspended slightly below the top 354 of the drum 350 from the monofilament line. In other embodiments, the stations 10, 110, 210 may be hung or situated in the drum 350 in any other suitable fashion. In yet other embodiments, a plurality of bait stations 10, 110, 210 may be hung or situated in the drum 350.

As assembled, the bait stations 10,110, 210 are hung from the monofilament line that is tied to one or both of the handles 370. The bait stations 10, 110, 210 are lowered into the cavity 366 of the drum 350 and allowed to hang, suspended within. The member 378 is screwed onto the hole 374 of the top 354, making the only access points to the bait station the openings 382 on the side 362 of the drum 350. Therefore, the drum 350 provides an area that avoids light.

In other embodiments, the drum 350 and the bait stations 10, 110, 210 may be constructed as a single structure. For example, the housing of the bait stations 10, 110, 210 may be formed as one piece with one or more of the first end, the second end, or the side. In one such embodiment, the interior of the side 362 may include fabric soaked in the sugar/toxin solution, such that the drum 350 forms in whole or in part the structure of the bait station. The amount of the side 362 covered by the fabric may include any functional amount. This embodiment would also allow a bait station 10, 110, 210, or a plurality of bait stations 10, 110, 210, to be situated within the cavity 366 in addition to the fabric covering the interior. The interior of the top 354 and the bottom 358 may also be covered in the fabric soaked in the sugar/toxin solution in addition to the side 362, or independently from the side 362. In another embodiment, the bait station 10, 110, 210 and the drum 350 may be constructed in a similar fashion as described above, but not including the monofilament line. Rather, the bait station 10, 110, 210, or a plurality of bait stations 10, 110, 210 would be constructed as a part of the drum 350 and would be hung or situated within the cavity 366 in any suitable fashion. In these embodiments, tube recesses may also be present throughout the drum to provide locations for the tubes 26 including the olfactory attractant. In other embodiments, the olfactory attractant may be provided directly to the interior of the drum 350, such as with the fabric covering the interior of the side 362.

Water can be supplied to the bottom 358 of the drum 350 to provide humidity to the cavity 366 and to the bait stations 10, 110, 210 to further attract insects. In some embodiments, a wick or porous material (not shown) may extend between the bait stations 10, 110, 210 and the water such that water is guided by absorption to the bait stations 10, 110, 210 by capillary action. Floral scents or wetted pads may be provided to the bottom 358 of the drum 350 instead of, or in addition to the water. As similarly described above, deterring material may also be provided in places of the drum 350 or the monofilament line to prevent ants from reaching the bait stations 10, 110, 210. Together, the black drum 350 and the water provide visual attraction supplemented with locally elevated humidity, and the station 10, 110, 210 positioned within the cavity provides the floral scents as well as the sugar/toxin solution in the fabric. Other visual cues can be used in conjunction with the black drum 350 to further enhance the attractiveness of the bait station.

Composition of Sugar/Toxin Solution

The sugar/toxin solution is a composition that is applied to at least a portion of the bait station and that comprises one or more sugars and one or more toxins. In some embodiments, the composition may also comprise one or more attractant.

Sugars

As used herein, sugars shall mean any carbohydrate that induces sugar foraging behavior in an insect. Sugars include, but are not limited to, glucose, fructose, galactose, sucrose, dextrose, and lactose. The sugar/toxin solution may include more than one sugar. The sugars may be present in any ratio. A preferred embodiment includes the use of unrefined sugar.

Toxins

As used herein, “toxin” is a compound or composition that kills or controls insects at some stage of life and includes, for example, larvacides and adulticides. An insect population may be controlled by applying the toxin in an amount sufficient to kill or control at least 10%, 15%, 20%, 25%, 30%, 35%, 40%, 45%, 50%, 55%, 60%, 65%, 70%, 75%, 80%, 85%, 90%, 95%, or any proportion of the population. Control or controlling includes killing, knocking down, or a combination thereof, of at least a portion of a population of insects. A population includes at least two such insects. In some embodiments, the toxin includes, but is not limited to, spinosad, neonicotinoid, carbamate, organophosphate, organochlorine, pyrethrum, pyrethrin, pyrethroid, chlofenapyr, ethiprole, sulfoxoflor, pyriproxyfen, boric acid, or any combination thereof. The sugar/toxin solution may include more than one toxin. The toxins may be present in any ratio.

Spinosad

Spinosad is an insecticide derived from Saccharopolyspora spinosa. S. spinosa occurs in over 20 natural forms, and over 200 synthetic forms (spinosoids). As used in this specification, spinosad includes at least one of Spinosyn A, Spinosyn D, or a combination thereof. Suitable spinosad formulation includes liquid soluble concentrate (SC) and solid water dispersible granule (WDG). Commercial spinosad insecticide products include those supplied by Dow AgroSciences (Indianapolis, Ind.), such as spinosad (mixture of Spinosyn A and Spinosyn D) under trade names Entrust® (wettable powder), Entrust® SC, and Tracer®, and spinetoram (mixture of 3′-O-ethyl-5,6-dihydro Spinosyn J (CAS No. 187166-40-1) and 3′-O-ethyl Spinosyn L (CAS No. 187166-15-0)) under trade names Delegate® WG, Radiant® SC, and Exalt™ SC.

Neonicotinoids

Neonicotinoids are insecticides that act on the central nervous system of insects. Neonicotinoids include, but are not limited to, acetamiprid, clothianidin, dinotefuran, imidacloprid, nitenpyram, thiacloprid, and thiamethoxam.

Carbamates

Carbamates are organic compounds derived from carbamic acid (NH₂COOH) and feature the carbamate ester functional group. Carbamates include, but are not limited to, aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, and triazamate.

Organophosphates

Organophosphates are esters of phosphoric acid that act on the enzyme acetylcholinesterase. Organophosphates include, but are not limited to, acephate, azamethiphos, azinphos-ethyl, azinphos-methyl, chlorethoxyfos, chlorfenvinphos, chlormephos, chlorpyrifos, methyl chlorpyrifos, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, omethoate, oxydemeton-methyl, parathion, methyl parathion, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, and vamidothion.

Organochlorines

Organochlorines are organic compounds containing at least one covalently bonded chlorine atom. Organochlorines include, but are not limited to, phthalimides, sulfamides, and chloronitriles, including, but not limited to, anilazine, captan, chlorothalonil, captafol, chlordane, dichlorodiphenyltrichloroethane (DDT), dicofol, dichlofluanid, dichlorophen, endosulfan, flusulfamide, folpet, hexachlorobenzene, heptachlor, pentachlorphenol and its salts, aldrin, dieldrin, endrin, mirex, phthalide, and tolylfluanid, N-(4-chloro-2-nitro-phenyl)-N-ethyl-4-methyl-benzenesulfonamide.

Pyrethrum and Pyrethrins

As used in this specification, the term “pyrethrum” refers to a crude extract composition that is derived from chrysanthemum-like flowers primarily grown in Kenya, Tanzania, and Australia (e.g., T. cinerariaefolium, C. cinerariaefolium, and C. coccineum) and comprises a mixture of the naturally occurring insecticidal ester compounds known as the “pyrethrins,” as further detailed in U.S. patent application Ser. No. 13/175,405, filed Jul. 1, 2011, published as U.S. Patent Publication No. 2013/0005688 A1 on Jan. 3, 2013, which is incorporated into this specification by reference in its entirety. “Pyrethrins” or “pyrethrin ester” is used in this specification as a collective term given to any combination of the six ester compounds (including refined pyrethrum) detailed in Table 1. While the terms “pyrethrins” and “pyrethrum” are sometimes used interchangeably, “pyrethrum” should be understood here to encompass crude extracts that contain pyrethrins. The pyrethrins in any given pyrethrum extract vary in relative amount, depending on factors such as the plant variety, where it is grown, and the time of harvest. Pyrethrins are commercially available from several sources throughout the world and, in the United States, are available from several sources including the product sold under the trade name Pyganic® MUP 20 by MGK (Minneapolis, Minn.). Pyganic® MUP 20 contains about 20% pyrethrins by weight. When the term “MUP 20” is used it refers to a MUP comprising about 20% pyrethrins by weight and includes, but is not limited to, Pyganic® MUP 20.

TABLE 1
Naturally occurring pyrethrin esters

| Common Name | CAS Number |
|---|---|
| Pyrethrins I: | |
| Jasmolin-I | 4466-14-2 |
| Cinerin-I | 25402-06-6 |
| Pyrethrin-I | 121-21-1 |
| Pyrethrins II: | |
| Jasmolin-II | 1172-63-0 |
| Cinerin-II | 121-20-0 |
| Pyrethrin-II | 121-29-9 |

Pyrethroid

The term “pyrethroid” is understood in the art to mean one or more synthetic compounds that act as an insecticide and are adapted from the chemical structure of pyrethrins. Non-limiting examples of pyrethroids include acrinathrin, allethrin, benfluthrin, benzylnorthrin, bioallethrin, bioethanomethrin, bioresmethrin, bifenthrin, cyclethin, cycloprothrin, cyfluthrin, beta-cyfluthrin, gamma-cyhalothrin, lamdba-cyhalothrin, cypermethrin, alpha-cypermethrin, beta-cypermethrin, zeta-cypermethrin, cyphenothrin, deltamethrin, empenthrin, esbiothrin, esfenvalerate, etofenprox, fenfluthrin, fenpropathrin, fenvalerate, flucythrinate, flumethrin, imiprothin, isopyrethrin I, kadethrin, metofluthrin, permethrin, 1RS cis-permethrin, phenothrin, prallethrin, resmethrin, silafluofen, sumithrin (d-phenothrin), tau-fluvalinate, tefluthrin, tetramethrin, tralomethrin, transfluthrin, and isomers of these compounds. In certain embodiments, the pyrethroid comprises at least one of permethrin, sumithrin, prallethrin, resmethrin, etofenprox, allethrin, alpha-cypermethrin, bifenthrin beta-cypermethrin, cyfluthrin, cypermethrin, deltamethrin, esfenvalerate, etofenprox, lamdba-cyhalothrin, and zeta-cypermethrin, which may be used with, for example, perilla oil, perillaldehyde, or carvone.

Additional information regarding pyrethrum, pyrethrins, and pyrethroids can be found in various references, reviews, and fact sheets, for example, Pyrethrum Flowers: Production, Chemistry, Toxicology, and Uses. John E. Casida and Gary B. Quistad (eds.), Oxford University Press, 1995; and “Pyrethrins & Pyrethroids” 1998 Fact Sheet published by the National Pesticide Telecommunications Network (NPTN) at Oregon State University, Corvallis, Oreg.

The sugar and the toxin can be present at any weight ratio suitable for both inducing sugar foraging behavior and controlling the insect. In some embodiments, the toxin or sugar can be present in an amount of at least about 0.003%, at least about 0.01%, at least about 0.05%, at least about 0.1%, at least about 0.5%, at least about 1%, at least about 2%, or at least about 3%, at least about 4%, at least about 6%, at least about 8%, at least about 10%, at least about 12%, at least about 15%, at least about 20%, at least about 25%, at least about 30%, at least about 35%, at least about 40%, at least about 50% or at least about 55%, at least about 60%, at least about 65%, at least about 70%, at least about 75%, at least about 80%, at least about 85%, at least about 90%, at least about 95%, and less than about 95%, less than about 90%, less than about 80%, less than about 75%, less than about 70%, less than about 65%, less than about 60%, less than about 55%, less than about 50%, less than about 45%, less than about 35%, less than about 30%, less than about 25%, less than about 20%, less than about 15%, less than about 10%, less than about 5%, less than about 2.5%, less than about 2%, less than about 1%, less than about 0.5%, or less than about 0.1% by weight of the sugar/toxin solution.

Preferably, the sugar used in the present device comprises sucrose, and the toxin used in the present device comprises spinosad, such as the commercially available spinosad products (Entrust®, Entrust® SC, and Tracer®) and spinetoram products (Delegate® WG, Radiant® SC, and Exalt™ SC). In some embodiments, technical grade spinosad is used. Typically, the sugar/toxin solution is prepared by dissolving the sugar and the toxin at a pre-determined ratio in a solvent. Preferably, the concentration of sugar in that solution is approximately 10%, and the concentration of spinosad in that solution is between 0.003%-1.0%. Suitable solvents include acetone. Other components of the solution can include suitable components such as an antibactericide, a mold inhibitor, and a UV-protectant.

Attractants

As used herein, “attractant” is a compound, composition, or element that attracts insects to a site. Attractants may include, but are not limited to, a bacterium capable of producing nonanoic acid, tetradecanoic acid, or methyl tetradecanoate; Bacillus thuringiensis; Lactococcus lactis; Klebsiella oxytoca; Shigella dysenteriae; Brevundimonas vesicularis; a supernatant of a culture of any of the aforementioned bacteria; nonanoic acid; tetradecanoic acid; or methyl tetradecanoate, or any combination thereof. Attractants of this variety are described in U.S. patent application Ser. No. 12/613,920, filed Nov. 6, 2009, published as U.S. Patent Publication No. 2010/0192451 A1 on Aug. 5, 2010, which is incorporated into this specification by reference in its entirety. Attractants may include visual or olfactory or other sensory attractants. Additional examples of attractants include, but are not limited to, designs, images, light, carbon dioxide, sugars, sugary scents, lactic acid, octenol, warmth, water vapor, and sound.

In one aspect of the present device, volatile organic compounds are used as olfactory attractants. In one embodiment, synthetic blends of phytochemicals that are strongly attractive to An. gambiae have been created de novo. For example, the blends of olfactory attractants are developed empirically, through behavioral bioassay in outdoor screenhouses, from various plant-based volatile organic compounds. These olfactory attractants are effective in attracting and inducing feeding by An. gambiae in a semi-natural setting in the presence of competing host plants and are useful for both trap and bait station types of devices.

In some embodiments, the present device includes at least one volatile organic compound. The volatile organic compounds include those occurring in the headspace or extracts of flowers known to attract mosquitoes and other insects in the field. Examples include 6-methyl-5-hepten-2-one, benzaldehyde, caryophyllene, hexanol, linalool, linalool oxide, ethylphenylacetate, methylsalicylate, myrcene, ocimene, phenylacetaldehyde, and pinene. Addition examples of suitable volatile organic compounds can be found in Nyasembe et al. (“Development and Assessment of Plant-Based Synthetic Odor Baits for Surveillance and Control of Malaria Vectors,” PLOS ONE, 2014, vol. 9, issue 2, e89818) and Nyasembe et al. (“Volatile Phytochemicals as Mosquito Semiochemicals,” Phytochemistry Letters, 2014, vol. 8, 196-201). Preferred volatile organic compounds used in the present device include hexanol, linalool, and phenylacetaldehyde.

The volatile organic compounds can be used alone as a single compound or as a blend of multiple compounds. A blend of volatile organic compounds may contain up to 10 individual compounds. For example, the blend of volatile organic compounds can contain at least two, at least three, at least four, at least five, at least six, at least seven, at least eight, and at least nine individual compounds. The blend of volatile organic compounds can contain less than ten, less than nine, less than eight, less than seven, less than six, less than five, less than four, and less than three individual compounds. In general, a higher dose of volatile organic compounds (used alone or as a blend) provides more effective attraction. In one embodiment, the present device includes a blend of volatile organic compounds as attractant for Anopheles gambiae. Examples of suitable blends of volatile organic compounds include a six-part blend of pinene, linalool, methylsalicylate, myrcene, phenylacetaldehyde, and benzaldehyde, each at a dose of 500 μl; a four-part blend consisting of pinene, linalool, methylsalicylate, and phenylacetaldehyde, each at a dose of 500 μl; a four-part blend consisting of pinene (100 μl), linalool (500 μl), methylsalicylate (10 μl), and phenylacetaldehyde (1000 μl); and a three-part blend of linalool (200 μl), hexanol (300 μl), and phenylacetaldehyde (700 μl). Preferably, the attractant used in the present device comprises a three-part blend of linalool at a concentration of 0.0625%-0.5%, 1-hexanol at a concentration of 0.0938%-0.75%, and phenylacetaldehyde at a concentration of 0.2188%-1.75%. In addition, the ratio of linalool:1-hexanol:phenylacetaldehyde is preferably maintained at approximately 2:3:7.

The volatile organic compounds can be suspended in a liquid carrier and applied to a substrate to control the release rate of such volatile compounds. The liquid carrier can be mineral oil, glycerol, or a solvent selected from water, alcohols, petroleum distillates, acids, and esters, and combinations thereof. The substrate can be an absorptive material that absorbs the volatile organic compound/carrier mixture to provide a reservoir of the compound. Examples of suitable substrates include cotton (e.g., cotton wick), nylon fiber strips, and polymeric gel. In one embodiment, the carrier for the volatile organic compounds is mineral oil, and the substrate is cotton wick. The substrate containing the volatile organic compound can be included in a separate component (e.g. the tube 26) of the present device to provide a reservoir of olfactory attractant.

Typically, the volatile organic compound (or blend of several compounds) is suspended or dissolved in the liquid carrier in an amount of at least about 0.005%, at least about 0.01%, at least about 0.05%, at least about 0.1%, at least about 0.5%, at least about 1%, at least about 2%, or at least about 3%, at least about 4%, at least about 6%, at least about 8%, at least about 10%, at least about 12%, at least about 15%, at least about 20%, at least about 25%, at least about 30%, at least about 35%, at least about 40%, at least about 50% or at least about 55%, at least about 60%, at least about 65%, at least about 70%, at least about 75%, at least about 80%, at least about 85%, at least about 90%, at least about 95%, and less than about 95%, less than about 90%, less than about 80%, less than about 75%, less than about 70%, less than about 65%, less than about 60%, less than about 55%, less than about 50%, less than about 45%, less than about 35%, less than about 30%, less than about 25%, less than about 20%, less than about 15%, less than about 10%, less than about 5%, less than about 2.5%, less than about 2%, less than about 1%, less than about 0.5%, or less than about 0.1% by weight of the suspension or solution.

Additional Components

In some embodiments, the sugar/toxin solution is substantially free of, or excludes any amount of, an insecticide synergist such as piperonyl butoxide (PBO), N-octyl bicycloheptene dicarboximide (MGK-264), piprotal, propyl isome, sesamex, sesamolin, or sulfoxide. The composition may be substantially free of, or exclude any amount of, one or more of piperonyl butoxide (PBO), N-octyl bicycloheptene dicarboximide (MGK-264), piprotal, propyl isome, sesamex, sesamolin, or sulfoxide in any combination.

In some embodiments, the sugar/toxin solution further includes at least one synergist. A synergist refers to an agent that synergizes the activity of an insecticide. Synergists may include, but are not limited to, the synergists identified in the preceding paragraph, perilla oil, one of its components, or a perillaldehyde analog, as detailed and described in U.S. patent application Ser. No. 14/149,513, filed Jan. 7, 2014, published as U.S. Patent Publication No. 2014/0121184 A1 on May 1, 2014, which is incorporated into this specification by reference in its entirety.

The sugar/toxin solution or the attractants, or any combination thereof, may comprise additional components including, but not limited to, herbicides, fungicides, nematicides, acaricides, bactericides, rodenticides, miticides, algicides, germicides, repellents, nutrients, other preservatives, and combinations thereof. Specific examples of herbicides include, without limitation, a urea, a sulfonyl urea, a phenylurea, a pyrazole, a dinitroaniline, a benzoic acid, an amide, a diphenylether, an imidazole, an aminotriazole, a pyridazine, an amide, a sulfonamide, a uracil, a benzothiadiazinone, a phenol, and a combination thereof. Specific examples of fungicides include, without limitation, a dithiocarbamate, a phenylamide, a benzimidazole, a substituted benzene, a strobilurin, a carboxamide, a hydroxypyrimidine, a anilopyrimidine, a phenylpyrrole, a sterol demethylation inhibitor, a triazole, and a combination thereof. Specific examples of acaricides or miticides include, without limitation, rosemary oil, thymol, spirodiclogen, cyflumetofen, pyridaben, diafenthiuron, etoxazole, spirodiclofen, acequinocyl, bifenazate, and any combination thereof.

Carriers

In some embodiments, sugar/toxin solution or the attractants, or any combination thereof, may include one or more carriers and/or diluents such as, for example, any solid or liquid or gas carrier or diluent that is commonly used in pesticidal, agricultural, or horticultural compositions. Suitably, any included additional carrier or diluent will not reduce the insecticidal efficacy of the composition, relative to the efficacy of the composition in the absence of the additional component. Carriers and diluents include, for example, solvents (e.g., water, alcohols, petroleum distillates, acids, and esters); mineral oil, glycerol, or a diluent that provides viscosity modifying properties; vegetable (including, but not limited to, methylated vegetable) and/or plant-based oils as well as ester derivatives thereof (e.g., wintergreen oil, cedarwood oil, rosemary oil, peppermint oil, geraniol, rose oil, palmarosa oil, citronella oil, citrus oils (e.g., lemon, lime, and orange), dillweed oil, corn oil, sesame oil, soybean oil, palm oil, vegetable oil, olive oil, peanut oil, and canola oil). The composition can include varying amounts of other components such as, for example, surfactants (e.g., non-ionic, anionic, cationic, and zwitterionic surfactants); fatty acids and fatty acid esters of plant oils (e.g., methyl palmitate/oleate/linoleate); and other auxiliary ingredients such as, for example, emulsifiers, dispersants, stabilizers, suspending agents, penetrants, coloring agents/dyes, UV-absorbing agents, and fragrances, as necessary or desired.

Amounts

The attractant or toxin or sugar can be present in an amount of at least about 0.005%, at least about 0.01%, at least about 0.05%, at least about 0.1%, at least about 0.5%, at least about 1%, at least about 2%, or at least about 3%, at least about 4%, at least about 6%, at least about 8%, at least about 10%, at least about 12%, at least about 15%, at least about 20%, at least about 25%, at least about 30%, at least about 35%, at least about 40%, at least about 50% or at least about 55%, at least about 60%, at least about 65%, at least about 70%, at least about 75%, at least about 80%, at least about 85%, at least about 90%, at least about 95%, and less than about 95%, less than about 90%, less than about 80%, less than about 75%, less than about 70%, less than about 65%, less than about 60%, less than about 55%, less than about 50%, less than about 45%, less than about 35%, less than about 30%, less than about 25%, less than about 20%, less than about 15%, less than about 10%, less than about 5%, less than about 2.5%, less than about 2%, less than about 1%, less than about 0.5%, or less than about 0.1% by weight of the composition.

Insects

As used herein, insects may include any sugar-foraging insect that is a nuisance, carries disease, or attacks mammals, or any combination thereof. Mammals may include, for example, humans, domesticated animals, and pets. In particular, insects may include, but are not limited to, mosquitoes. “Mosquito” is understood to refer to any species of the approximately 3,500 species of the insect that is commonly associated with and given the common name, “mosquito.” Mosquitoes span 41 insect genera, including the non-limiting examples of Aedes, Culex, Anopheles (carrier of malaria), Coquillettidia, and Ochlerotatus. In a preferred embodiment, the target insect is the mosquito species Anopheles gambiae, which is an African malaria vector.

Insects may further include agronomic pests. Agronomic pests include larvae of the order Lepidoptera, such as armyworms, (e.g., beet armyworm (Spodoptera exigua)), cutworms, loopers (e.g., cabbage looper (Trichoplusia ni)), and heliothines in the family Noctuidae (e.g., fall armyworm (Spodoptera fugiperda J. E. Smith), beet armyworm (Spodoptera exigua Hubner), black cutworm (Agrotis ipsilon Huihagel), and tobacco budworm (Heliothis virescens Fabricius)); borers, casebearers, webworms, coneworms, cabbageworms and skeletonizers from the family Pyralidae (e.g., European corn borer (Ostrinia nubilalis Hubner), navel orangeworm (Amyelois transitella Walker), corn root webworm (Crambus caliginosellus Clemens), and sod webworms (Pyralidae: Crambinae) such as sod webworm (Herpetogramma licarsisalis Walker)); leafrollers, budworms, seed worms, and fruit worms in the family Tortricidae (e.g., codling moth (Cydia pomonella Linnaeus), grape berry moth (Endopiza viteana Clemens), and oriental fruit moth (Grapholita molesta Busck)); and many other economically important Lepidoptera (e.g., diamondback moth (Plutella xylostella Linnaeus), pink bollworm (Pectinophora gossypiella Saunders), silverleaf whitefly (Bemisia argentifolii), and gypsy moth (Lymantria dispar Linnaeus)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus), annual bluegrass weevil (Listronotus maculicollis Dietz), bluegrass billbug (Sphenophorus parvulus Gyllenhal), hunting billbug (Sphenophorus venatus vestitus), and Denver billbug (Sphenophorus cicatristriatus Fahraeus)); flea beetles, cucumber beetles, rootworms, leaf beetles, potato beetles, and leafminers in the family Chrysomelidae (e.g., Colorado potato beetle (Leptinotarsa decemlineata Say)); western corn rootworm (Diabrotica virgifera virgifera LeConte); western flower thrip (Frankliniella occidentalis)); chafers and other beetles from the family Scaribaeidae (e.g., Japanese beetle (Popillia japonica Newman), oriental beetle (Anomala orientalis Waterhouse), northern masked chafer (Cyclocephala borealis Arrow), southern masked chafer (Cyclocephala immaculata Olivier), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae; bark beetles from the family Scolytidae; flour beetles from the family Tenebrionidae; leafhoppers (e.g., Empoasca spp.) from the family Cicadellidae; planthoppers from the families Fulgoroidae and Delphacidae (e.g., corn plant hopper (Peregrinus maidis)); treehoppers from the family Membracidae; psyllids from the family Psyllidae; whiteflies from the family Aleyrodidae; aphids from the family Aphididae, such as Aphis gossypii (cotton melon aphid), Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), Toxoptera citricida Kirkaldy (brown citrus aphid) and green peach aphid (Myzus persicae); phylloxera from the family Phylloxeridae; mealybugs from the family Pseudococcidae; scales from the families Coccidae, Diaspididae, and Margarodidae; lace bugs from the family Tingidae; stink bugs from the family Pentatomidae; flat mites in the family Tenuipalpidae (e.g., citrus flat mite (Brevipalpus lewisi McGregor)); rust and bud mites in the family Eriophyidae and other foliar feeding mites; chinch bugs (e.g., hairy chinch bug (Blissus leucopterus hirtus Montandon) and southern chinch bug (Blissus insularis Barber) and other seed bugs from the family Lygaeidae); spittlebugs from the family Cercopidae; squash bugs from the family Coreidae; red bugs and cotton stainers from the family Pyrrhocoridae; and adults and immatures of the order Orthoptera including grasshoppers, locusts, and crickets (e.g., migratory grasshoppers (e.g., Melanoplus sanguinipes Fabricius, M. differentialis Thomas)), American grasshoppers (e.g., Schistocerca americana Drury), desert locust (Schistocerca gregaria Forskal), migratory locust (Locusta migratoria Linnaeus), bush locust (Zonocerus spp.); adults and immatures of the order Diptera including insects from the genus Culicoides, leafminers, midges, fruit flies (Tephritidae), frit flies (e.g., Oscinella frit Linnaeus)), soil maggots; adults and nymphs of the orders Hemiptera and Homoptera such as plant bugs from the family Miridae; adults and immatures of the order Thysanoptera including onion thrips (Thrips tabaci Lindeman), flower thrips (Frankliniella spp.), and other foliar feeding thrips; and cicadas from the family Cicadidae. Agronomic pests also include Classes Nematoda, Cestoda, Trematoda, and Acanthocephala including economically important members of the orders Strongylida, Ascaridida, Oxyurida, Rhabditida, Spirurida, and Enoplida such as economically important agricultural pests (e.g., root knot nematodes in the genus Meloidogyne, lesion nematodes in the genus Pratylenchus, and stubby root nematodes in the genus Trichodorus). Agronomic and non-agronomic pests include nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fiabricius), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); adults and larvae of the order Dermaptera including earwigs from the family Forficulidae (e.g., European earwig (Forficula auricularia Linnaeus), and black earwig (Chelisoches morio Fabricius)). Also included are adults and larvae of the order Acari (mites) such as spider mites and red mites in the family Tetranychidae (e.g., European red mite (Panonychus ulmi Koch), two spotted spider mite (Tetranychus urticae Koch), and McDaniel mite (Tetranychus mcdanieli McGregor)); mites important in human and animal health (e.g., dust mites in the family Epidermoptidae, follicle mites in the family Demodicidae, and grain mites in the family Glycyphagidae); ticks in the order Ixodidae (e.g., deer tick (Ixodes scapularis Say), Australian paralysis tick (Ixodes holocyclus Neumann), American dog tick (Dermacentor variabilis Say), and lone star tick (Amblyomma americanum Linnaeus)); scab and itch mites in the families Psoroptidae, Pyemotidae, and Sarcoptidae); crickets such as house cricket (Acheta domesticus Linnaeus), mole crickets (e.g., tawny mole cricket (Scapteriscus vicinus Scudder), and southern mole cricket (Scapteriscus borellii Giglio-Tos)); flies including house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera; mosquitoes (e.g., Aedes spp., Anopheles spp., Culex spp.), black flies (e.g., Prosimulium spp., Simulium spp.), biting midges, sand flies, biting sand flies, sciarids, and other Nematocera; insect pests of the order Hymenoptera including ants (e.g., red carpenter ant (Camponotus ferrugineus Fabricius), black carpenter ant (Camponotus pennsylvanicus De Geer), Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Forster), odorous house ant (Tapinoma sessile Say)); insect pests of the Family Formicidae including the Florida carpenter ant (Camponotus floridanus Buckley), white-footed ant (Technomyrmex albipes fr. Smith), big headed ants (Pheidole spp.), and ghost ant (Tapinoma melanocephalum Fabricius); bees (including carpenter bees), hornets, yellow jackets, wasps, and sawflies (Neodiprion spp.; Cephus spp.); insect pests of the order Isoptera including termites in the Termitidae (ex. Macrotermes sp.), Kalotermitidae (ex. Cryptotermes sp.), and Rhinotermitidae (ex. Reticulitermes spp., Coptotermes spp.), families the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch); long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Arthropod pests also include spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus). In some embodiments, the composition comprising attractant and/or toxin does not attract or kill bees.

Embodiments described in this specification are generally designed to kill insects in the adult stage, but can be configured and used to kill insects in other life stages.

One advantage of the invention is that particular orders or species can be targeted by varying the attractants, including but not limited to the visual attractant, used in the bait station. In that regard, embodiments can be tailored to the region where they will be used to avoid killing non-target species. Preferable embodiments of the invention target flying insects where the bait station can be hung or otherwise located such that ground-dwelling insects like ants cannot reach the bait station to consume the sugar/toxin solution.

### EXAMPLES

### Example 1

### Visual Preference for Anopheles gambiae

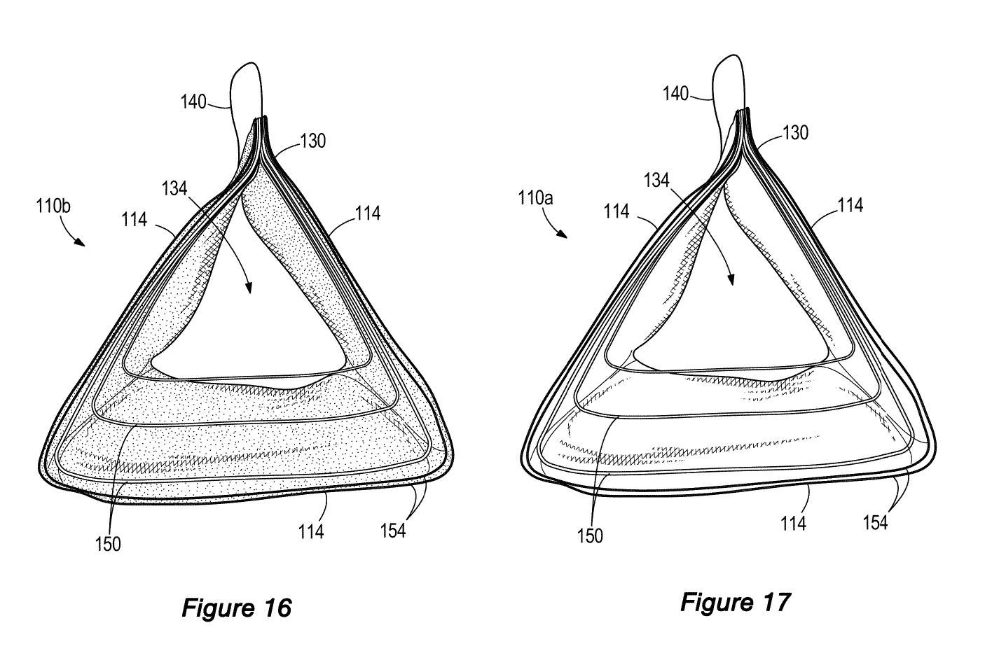

Prototypes of first and second polygonal bait stations 110a, 110b were made by wrapping different colors of fabric (e.g., a jute sheet) around a delta-shape metal frame 150. Each side was 7 inches, and its length was 10 inches. To make the first feeding station (e.g., the light colored feeding station 110a, FIG. 17), a 22-by-10-inch piece of a first piece of fabric (not shown) was placed between two sheets of 22-by-10 inch light-colored fabric 154 (e.g, vanilla jute). Then, the frame 150 was wrapped by the fabric sheets 154, and coupled at one end so that both interior and the exterior of the light colored feeding station 110a had the same color. To make the second feeding station 110b (e.g., the black feeding station, FIG. 16), the same process described above for the light-colored feeding station 110a was used except that black fabric (e.g., jute) was used instead of the light-colored fabric. Although not illustrated herein, it should be understood that FIGS. 16 and 17 may also include conduits 122 for tubes 26 and/or one or more inserts 16 as discussed above with respect to FIGS. 1-10.

The light-colored feeding stations 110a were impregnated with a mixture of 100 ml sucrose solution (50%) and 100 mg Fluorescent Brightener 28 (Tinopal), whereas 100 mg rhodamine B was added to the sucrose solution impregnating the fabric of the black stations 110b. Before starting the tests in a mesocosm, two groups of mosquitoes were allowed to feed on the dyed solutions overnight to ensure that the mixtures were palatable to the mosquitoes, and that the dyes in the mosquitoes' bodies could be observed under UV light. Tinopal looks clear in normal lightning, but turns blue under UV light. Rhodamine B appears red in both normal lighting and UV lights.

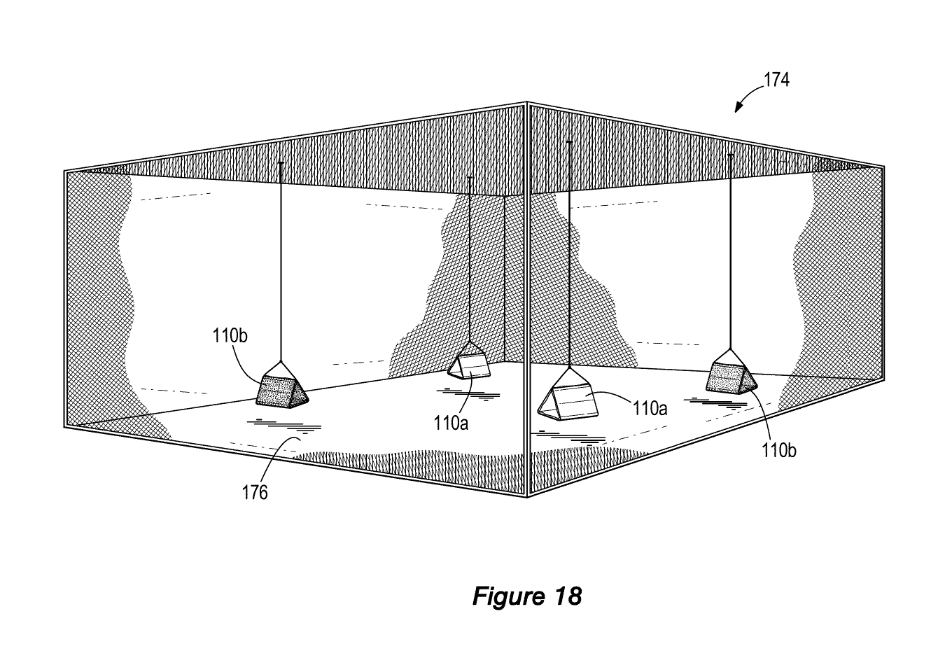

All tests were conducted in two mesocosms 174 (only one is shown in FIG. 18) with 65% RH at 24-28° C. One 18-by-24 foot white tarp 176 was placed on the floor of each mesocosm, thus the whole mesocosm was substantially white. In each mesocosm 174, four stations were hung from the ceiling light fixtures by clear nylon monofilament (described above), so that the bottom of the stations were 20-30 cm above the floor of the mesocosm, and about 3 feet (1 m) from each of the two walls (FIG. 18). FIG. 18 illustrates the exemplary mesocosm, which included two of each the light colored and the black feeding stations 110a, 110b, although only one of the light-colored feeding stations 110a is seen in FIG. 18. In the last two replicates (out of a total of five replicates), one clear container with 2 liters water was placed in each mesocosm.

Five replicates were run in three nights. Each evening, between 220 and 320 1-day old mosquitoes (Anopheles gambiae) that had been kept on water since emergence were released in each mesocosm. The mosquitoes were collected by power aspirator the next morning (˜15 hr after release), frozen, and inspected for presence of the dyes. Male and female mosquitoes were categorized in one of the five groups: rhodamine B (black station), tinopal (light colored station), trace of rhodamine B (black station), both dyes (both stations), and no dye (unfed, which means that the mosquitoes did not visit a station).

Before aspirating mosquitoes from the mesocosms, the stations were checked to approximate the number of resting mosquitoes. Whereas light-colored stations 110a had very few mosquitoes (<5%) within them, many were observed resting inside the black stations 110b (FIG. 18). The mosquitoes that were disturbed during the morning collection tended to fly back to the black stations. Table 2 shows the mean proportion of all recaptured mosquitoes in the five categories, according to the dye they contained. The data of all five replicates have been combined. Details for each replicate are shown in Table 3.

TABLE 2

| | Rhodamine B | | | Tinopal (Light- | | | | | | Trace of Rhodamine | | | | | | Total Number of | | |
|---|---|---|---|---|---|---|---|---|---|---|---|---|---|---|---|---|---|---|
| | (Black Station) | | | Colored Station) | | | Both | | | B (Black Station) | | | Unfed | | | Released Mosquitoes | | |
| Sex | F | M | F + M | F | M | F + M | F | M | F + M | F | M | F + M | F | M | F + M | F | M | F + M |
| Mean | 58.5 | 38.5 | 47.8 | 3.5 | 5.0 | 4.3 | 2.6 | 1.3 | 1.9 | 23.7 | 40.8 | 32.8 | 11.7 | 14.5 | 13.2 | 606 | 671 | 1277 |
| SE | 9.9 | 5.5 | 7.4 | 1.3 | 2.3 | 1.8 | 1.2 | 0.7 | 0.8 | 9.0 | 4.9 | 6.8 | 4.5 | 3.2 | 3.3 | | | |

When the data from the two rhodamine B groups (=Black) are combined, the results were as follows: 82.3% females and 79.2% males (average 80.6% combined sexes, SE=1.9%) had fed from the sugar on the black stations (SE: 2.2 and 2.1%, respectively). Details for each replicate are shown in Table 3.

TABLE 3

| | | | Rhodamine B | | | Trace of Rhodamine | | | | | | Tinopal (Light- | | |
|---|---|---|---|---|---|---|---|---|---|---|---|---|---|---|
| Repli- | Black | | (Black Station) | | | B (Black Station) | | | All Black | | | Colored Station) | | |
| cate | position | Sex | F | M | F + M | F | M | F + M | F | M | F + M | F | M | F + M |
| 1 | NW, | No. | 127 | 69 | 196 | 5 | 51 | 56 | 132 | 120 | 252 | 11 | 20 | 31 |
| | SE | % | 77.44 | 41.82 | 59.57 | 3.05 | 30.91 | 17.02 | 80.49 | 72.73 | 76.60 | 6.71 | 12.12 | 9.42 |
| 2 | NW, | No. | 72 | 59 | 131 | 21 | 57 | 78 | 93 | 116 | 209 | 2 | 5 | 7 |
| | SE | % | 67.29 | 42.75 | 53.47 | 19.63 | 41.30 | 31.84 | 86.92 | 84.06 | 85.31 | 1.87 | 3.62 | 2.86 |
| 3 | NE, | No. | 83 | 71 | 154 | 7 | 37 | 44 | 90 | 108 | 198 | 7 | 11 | 18 |
| | SW | % | 77.57 | 55.04 | 65.25 | 6.54 | 28.68 | 18.64 | 84.11 | 83.72 | 83.90 | 6.54 | 8.53 | 7.63 |
| 4 | NE, | No. | 40 | 29 | 69 | 60 | 60 | 120 | 100 | 89 | 189 | 3 | 1 | 4 |
| | SW | % | 29.85 | 25.22 | 27.71 | 44.78 | 52.17 | 48.19 | 74.63 | 77.39 | 75.90 | 2.24 | 0.87 | 1.61 |
| 5 | NW, | No. | 38 | 34 | 72 | 42 | 63 | 105 | 80 | 97 | 177 | 0 | 0 | 0 |
| | SE | % | 40.43 | 27.42 | 33.03 | 44.68 | 50.81 | 48.17 | 85.11 | 78.23 | 81.19 | 0.00 | 0.00 | 0.00 |

| | | | | | | | | | | | | |
|---|---|---|---|---|---|---|---|---|---|---|---|---|
| Average | 58.52 | 38.45 | 47.81 | 23.73 | 40.78 | 32.77 | 82.25 | 79.22 | 80.58 | 3.47 | 5.03 | 4.30 |
| SE | 9.87 | 5.49 | 7.41 | 9.01 | 4.87 | 6.79 | 2.18 | 2.12 | 1.89 | 1.34 | 2.31 | 1.80 |

| Repli- | Black | | Both | | | Unfed | | | Total | | |
|---|---|---|---|---|---|---|---|---|---|---|---|
| cate | position | Sex | F | M | F + M | F | M | F + M | F | M | F + M |
| 1 | NW, | No. | 6 | 2 | 8 | 15 | 23 | 38 | 164 | 165 | 329 |
| | SE | % | 3.66 | 1.21 | 2.43 | 915 | 13.94 | 11.55 | | | |
| 2 | NW, | No. | 3 | 5 | 8 | 9 | 12 | 21 | 107 | 138 | 245 |
| | SE | % | 2.80 | 3.62 | 3.27 | 8.41 | 8.70 | 8.57 | | | |
| 3 | NE, | No. | 7 | 2 | 9 | 3 | 8 | 11 | 107 | 129 | 236 |
| | SW | % | 6.54 | 1.55 | 3.81 | 2.80 | 6.20 | 4.66 | | | |
| 4 | NE, | No. | 0 | 0 | 0 | 31 | 25 | 56 | 134 | 115 | 249 |
| | SW | % | 0.00 | 0.00 | 0.00 | 23.13 | 21.77 | 22.49 | | | |
| 5 | NW, | No. | 0 | 0 | 0 | 14 | 27 | 41 | 94 | 124 | 218 |
| | SE | % | 0.00 | 0.00 | 0.00 | 14.89 | 21.77 | 18.81 | | | |

| | | | | | | |
|---|---|---|---|---|---|---|
| Average | 2.60 | 1.28 | 1.90 | 11.68 | 14.47 | 13.22 |
| SE | 1.23 | 0.67 | 0.81 | 3.45 | 3.23 | 3.28 |

| | | | |
|---|---|---|---|
| Total | 606 | 671 | 1277 |

Without being bound by any particular theory, the following hypothesis can be made. The proportion among recaptured mosquitoes in each dye category indicates that the black feeding station was fed upon far more than the light-colored one, and therefore black was a preferred color. The high proportion of mosquitoes with a strong rhodamine B marker may be an indication of sugar feeding in the black stations later at night, whereas those with a trace of rhodamine B may have ingested a low amount of sugar from the black stations or had fed earlier at night, allowing a longer period of sugar digestion. It should be noted that the proportion of the mosquitoes that remained unfed (13.2% combined sexes) was higher than the proportion of mosquitoes that took sugar from the light-colored delta stations only (4.3%). Very few mosquitoes (1.9%) fed on both colors of the stations, probably because majority of mosquitoes were satiated during the first encounter with the sugar solution.

The high feeding rates on the black delta stations in this experiment do not necessarily mean that black is the most attractive color for Anopheles gambiae, but are evidence that this species can distinguish contrasts, which therefore act as a visual attractant.

### Example 2

### Attractants for Anopheles gambiae

Attraction tests were conducted in two sizes of outdoor screenhouses (˜5.5×7 m and 11×7 m, each>3 m high) at the Mbita research station (Odhiambo Campus, Kenya) of the International Centre of Insect Physiology & Ecology (ICIPE). The screenhouses provided a semi-natural physical environment that allowed experimental control over mosquito sample size and recovery of marked and/or released mosquitoes. It was noted that fluctuations of weather conditions would cause variations in flight behavior from night to night, affecting attraction to volatile organic compounds. The walls and ceiling were lined with netting to reduce interference from ants and spiders and to prevent mosquitoes from aggregating in the vaulted ceiling. The floor was a bed of sand, dampened daily. On the floor at each corner of the screenhouse, dampened pots served as resting harborages, which the mosquitoes typically entered at dawn. When local potted plants were included in the environment, they were spaced throughout the floor.

Additional attraction tests were conducted in two greenhouse-enclosed mesocosms (˜4.9×5.7 m, each 3 m high) at The Ohio State University. These tests served as follow-ups to the outdoor study, using volatile organic compound blends already identified as being attractive. The mesocosms minimized weather's effect on mosquito behavior and allowed for very high rate of recapture (by trap+aspirator) at the end of the test, allowing accurate attraction rates to be calculated. The results confirmed the blends' performance, but gave higher scores.

Tested mosquitoes were the Mbita strain of Anopheles gambiae, colonized locally about 14 years ago, but with infusions of field material in some subsequent years, to maintain genetic diversity. Adults emerging each night from daily collections of pupae were fed water only and were tested in the screenhouses the following night. At this age, both sexes still have adequate deposits of somatic energy from larval feeding but will die during the following 1.5 days without nutrients. Before sunset, the volatile organic compounds baits were installed in mosquito traps, their fans were turned on, and the mosquitoes were released from a small cage prepared for that purpose.

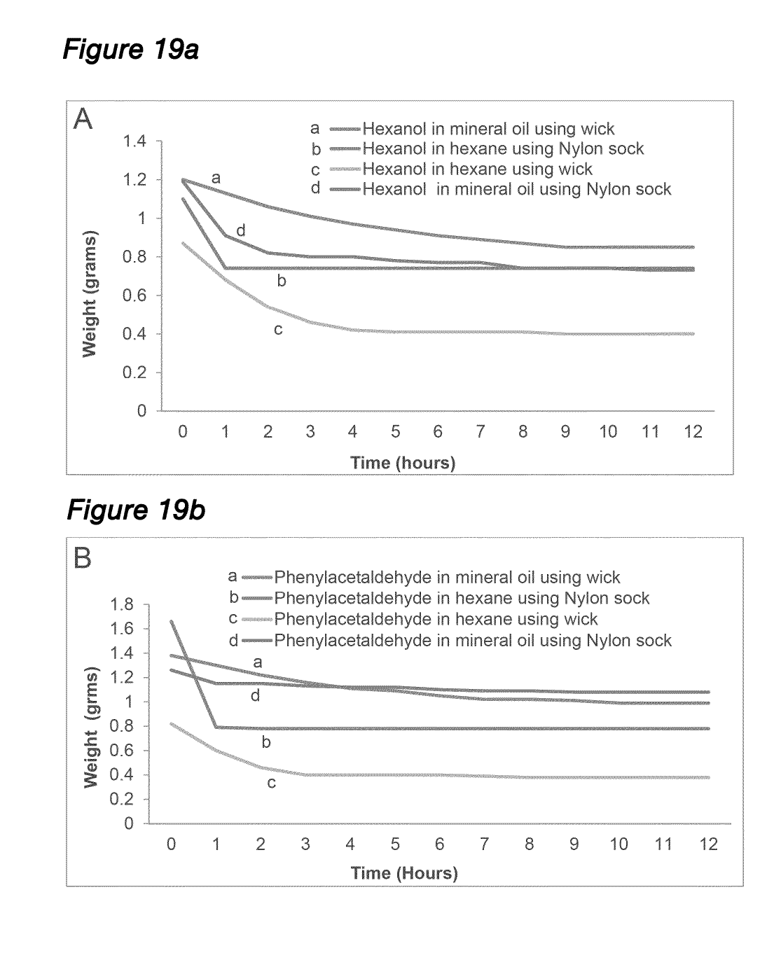

Attraction was measured as the number of mosquitoes caught in MM-X or BG Sentinel traps baited with plant-based volatile organic compounds. The volatile organic compounds were prepared as individual compounds suspended in mineral oil, which controlled release rate according to dosage (concentration) while also retarding release rate of all compounds. Each compound was released separately from other compounds when more than one was released simultaneously. The oil-volatile organic compound suspensions were applied to two different types of release substrates: long nylon fabric strips in the exhaust tube of the trap, and short cotton wicks suspended in a wire basket beneath the exhaust tube. Measures of weight loss of compounds from these substrates indicated that the wicks gave a smoother and more gradual release rate during the trapping period. As an example of the tested volatile organic compounds, the release profiles of hexanol and phenylacetaldehyde (suspended in hexane or mineral oil, applied to nylon sock or cotton wick) as measured in a MM-X trap is shown in FIGS. 19a and 19b, respectively. The release profiles of hexanol, linalool oxide, ocimene, pinene, and 6-methyl-5-hepten-2-one are similar to phenylacetaldehyde.

The layout of traps was designed to maximize discrimination among traps releasing different plant-based volatile organic compounds or releasing none (the blank control). The small screenhouses contained 2 traps, positioned diagonally. The large screenhouses contained 4 traps. In both sizes, the traps were near the corners, but not so close to the netting walls as to interfere with mosquito flight around the traps or the free flow of the odor plume from the traps. For replicates of each test, the positions of the traps were rotated, to minimize positional bias for one of these variables: a particular compound, particular dose of a compound, or particular combination of several compounds or their proportions. In early tests, a blank trap was always included. But after establishing that a blank trap never caught more than 10 mosquitoes, out of 300-400 released, blank traps were usually replaced by one with a bait using volatile organic compounds. The number trapped out of the total number released, expressed as a percentage, was seldom calculated, because of the large and variable numbers of mosquitoes unaccounted for by trap and aspirator recapture. Instead, the effectiveness of the volatile organic compounds or blends of compounds in attracting mosquitoes was evaluated based on the actual number of mosquitoes caught by the trap.

a) Single Compounds. About 20 volatile organic compounds of interest were selected for potential testing. The list was a composite subset of a) those previously demonstrated to attract mosquitoes, b) those found in the headspace or extracts of plants that we have found to be particularly attractive to Anopheles gambiae in the lab or field, and c) those frequently occurring in the headspace of flowers known to attract mosquitoes and other insects in the field. From that long list, a shorter list of 3-5 volatile organic compounds were identified as particularly likely to produce attraction.

b) Blends of Compounds. Two or more compounds were tested together, released simultaneously but separately within a single trap. These started with combinations of single compounds that showed indications of attractiveness by themselves, according to a minimum of 20-mosquitoes-trapped criterion. These were designated as blends, though they were not mixed prior to release. On the nylon strips they were separated by applying each suspension in a long line, sometimes by using 2-3 strips, each with 2-3 suspensions of volatile organic compounds. When cotton wicks were deployed, one suspension was applied to each end of a wick, and 3-4 wicks were sometimes used. The most promising blends were investigated further, by modifying the proportions of their components and by subtracting components to determine the essential parts contributing to their attractiveness. Typically, blends containing three to ten components were investigated in this manner.

To assess attraction of volatile organic compounds in marked-bait station, a piece of fabric was impregnated with concentrated sugar containing a dye and a volatile compound or blend of compounds. Among all mosquitoes recovered the next morning, the proportion containing the dye gave an accurate indication of the number attracted to the fabric, landing on it, and consequently feeding.

Results. In all cases, the numbers of mosquitoes caught in plant-based volatile organic compound-baited MM-X traps were represented by similar proportions of both sexes, in accordance with nectar-feeding studies in the field. In general, single compounds in higher dosages (and therefore higher release rates) gave higher attraction scores. This was particularly obvious for caryophyllene, linalool, linalool oxide, ethylphenylacetate, and ocimene. Hexanol was notable for giving good scores even at low dosages, with little or no improvement at higher doses. Linalool oxide was expected to provide strong attraction, and phenylacetaldehyde moderately strong attraction, in view of published results. They proved to be weak or mediocre in these screenhouse tests. The great majority of single compounds gave poor to weak attraction scores (<20) at all doses tested, including those volatile organic compounds that proved to be important components of attractive blends (see below). No screenhouse-position effects were noted, but rain and wind appeared to diminish attraction scores.

Blends consisting of up to 10 ingredients were investigated. Most blends initially tested contained 5 or 6 compounds, many of them already having scored moderately well in single-compound tests. The highest attraction scores were achieved, however, with blends not performing particularly well as singles. But similar to single compounds, higher doses of blends generally gave higher attraction scores. The highest score reported (139) came from a six-part blend of pinene, linalool, methylsalicylate, myrcene, phenylacetaldehyde, and benzaldehyde, each at a dose of 500 μl. Blends of four compounds also gave relatively good attraction, and varied according to the proportions of its constituents. For example a four-part blend consisting of pinene, linalool, methylsalicylate, and phenylacetaldehyde, each at 500 μl, gave a score of 49. The same four-part blend, but at doses of 100, 500, 10, and 1000 μl, respectively, gave a capture score of 80 mosquitoes. Several 3-part blends also gave capture scores in the 30-50 range. For example, a blend of linalool (200 μl), hexanol (300 μl), and phenylacetaldehyde (700 μl) gave a score of 79, and was used routinely in further studies.

For bait stations, a preliminary experiment was carried out with 10 small square pieces of cloth (˜10 cm) soaked in a mixture of a multi-part volatile organic compounds blend, sugar, and dye. The cloths were hung on potted local plants, distributed throughout the screenhouse and including many known to provide nectar to An. gambiae. The results demonstrated that about 49% of the mosquitoes visited these stations overnight. When it was repeated with only one station in the same screenhouse, nevertheless 21% fed on the station in a single night, despite the fact that many of the unmarked mosquitoes had fed on natural nectar from the available plants. Similar experiments with a 3-part blend (linalool:hexanol:phenylacetaldehyde=2:3:7) showed that on successive nights 59% visited 8 bait stations overnight, 68% and 64% visited 6 stations, 28% visited 2 stations, and 23% and 8% visited 1 station, which was in competition with abundant natural sources of sugar.

### Example 3

### Anopheles gambiae Feeding on Dry and Moist Fabric

Materials. Female mosquitoes of Anopheles gambiae Mbita strain were studied for their feeding behavior on fabric impregnated with sucrose solution.
1. Fabric sleeves: white fabric envelopes.
2. Gel packet inserts: white fabric objects with water-absorbent material inside.
3. Moistened gel packet inserts: gel packet inserts that were exposed to steam.
4. Sucrose solution: 10% sucrose solution prepared by dissolving 20 grams of sucrose per 200 ml of distilled water.
5. Dyed sucrose solution: 10% sucrose solution with two drops of food dye added to color the solution deeply.
6. Cups: cups to hold mosquitoes and preparations of fabric sleeves with dyed sucrose solution.
7. Mosquitoes: females of Anopheles gambiae Mbita strain.

Method. Dyed sucrose solutions were prepared and stored in the 4° C. refrigerator. Red was assigned to the dry treatments and blue/green to the moist treatments. Ten fabric sleeves were soaked in dyed sucrose solution, five in each color, hung in the fume hood in the lab on string with paper clips, and allowed to dry in the fume hood until dry to the touch. After they were dried, the blue/green sleeves received moistened, gel packet inserts. Moistening was done by presenting the packets to steam generated over boiling water. The other five fabric envelopes were left without inserts and were dry. One envelope was placed into a ca. ½ L volume cup and held in place with a paper clip. Into each cup were transferred 15 female mosquitoes by use of a mouth pipette. Cups were transferred to an incubator kept at 27° C. and 85% RH. The number of dead mosquitoes in the cups was counted daily.

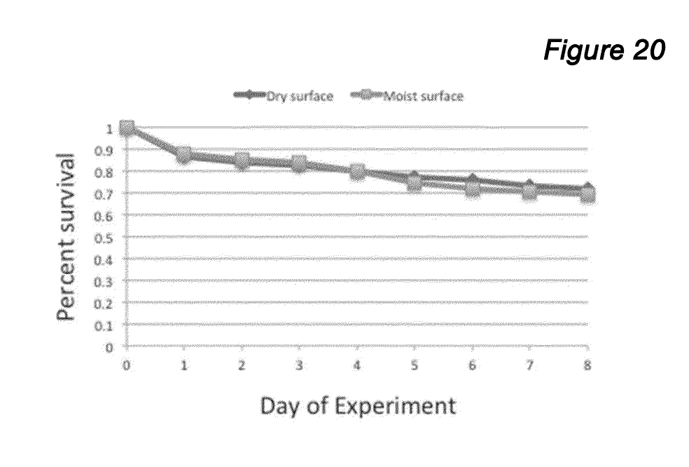

Results. In one experiment, a similar mosquito survival rate was observed in the dry surface and moist surface treatments during the first eight days of the experiment (resulting in about 70% survival at day 8, as shown in FIG. 20). One mosquito was found still alive in a dry surface treatment about 4 weeks after the experiment was set up. Mosquitoes were observed daily resting on and feeding from the envelopes, whether dry or moist. Red or blue/green color was evident in the abdomens, indicating that sugar solution was imbibed from the fabrics in both dry surface and moist surface treatments.

Conclusion. Anopheles gambiae females fed readily on sugar presented in a dry surface or as a moistened surface from fabric material. Without sugar or any other source of energy, mosquitoes will rapidly die in cages. Nevertheless, mortality was low and conversely survival very high for one week and was comparable in cages with dry surface and moist surface sugar sources. These findings support the conclusion that Anopheles gambiae can obtain sugar from a dry surface, albeit in a humid environment, and without any water source.

For reasons of completeness, various aspects of the invention are set out in the following numbered clauses:

Clause 1. A bait station comprising: a housing that comprises a flexible portion; a composition contained on or in the housing, the composition comprising at least one sugar and at least one toxin; an insert coupled to the housing; and at least one olfactory attractant contained in the insert.

Clause 2. The bait station of clause 1, wherein the insert is a first insert and the bait station further comprises a second insert coupled to the housing, the second insert configured to adsorb moisture.

Clause 3. The bait station of clause 2, wherein the second insert comprises silica beads, a superabsorbent material, or a combination thereof.

Clause 4. The bait station of clause 1, further comprising a visual attractant on an exterior surface of the housing.

Clause 5. The bait station of clause 1, wherein the housing is black.

Clause 6. The bait station of clause 1, wherein the housing comprises at least three panels, the panels coupled to one another and defining an opening.

Clause 7. The bait station of clause 6, wherein each of the at least three panels comprises a first side and a second side, the first side defining a portion of the exterior surface of the housing and the second side defining a portion of an interior surface of the housing.

Clause 8. The bait station of clause 7, wherein each of the first and the second sides of each panel is constructed from a fabric including one or more of jute, natural waxes, pectin, sugars, cellulose, protein, organic polymers, natural cotton, linen, flax, or wool.

Clause 9. The bait station of clause 7, further comprising a visual attractant on at least one of the first sides of the at least three panels.

Clause 10. The bait station of clause 7, further comprising a visual attractant on each of the first sides of the at least three panels.

Clause 11. The bait station of clause 7, wherein one of the at least three panels is a dark color on both the first side and the second side.

Clause 12. The bait station of clause 7, wherein the insert is a first insert and the bait station further comprises a second insert that is positioned between the first side and the second side of at least one of the at least three panels, the second insert configured to adsorb moisture.

Clause 13. The bait station of clause 7, wherein a conduit is positioned and extends between the first side and the second side of at least one of the at least three panels, the conduit configured to receive the insert.

Clause 14. The bait station of clause 6, wherein the flexible portion is at least one of the panels.

Clause 15. The bait station of clause 1, wherein the visual attractant is one of a color or a pattern.

Clause 16. The bait station of clause 1, wherein the visual attractant is a dark color.

Clause 17. The bait station of clause 16, wherein the dark color is black.

Clause 18. The bait station of clause 1, wherein the olfactory attractant comprises a volatile organic compound.

Clause 19. The bait station of clause 1, wherein the olfactory attractant is selected from the group consisting of pinene, linalool, methylsalicylate, myrcene, phenylacetaldehyde, benzaldehyde, 1-hexanol, and phenylacetaldehyde, or any combination thereof.

Clause 20. The bait station of clause 1, further comprising a drum including a body having a first end, a second end, a side extending from the first end to the second end, the first end, the second end, and the side defining a cavity, the second end configured to receive and retain water within the cavity, the side comprises at least one opening that provides access to the cavity, the housing being suspended from the first end.

Clause 21. The bait station of clause 1, further comprising a drum including a body having a first end, a second end, a side extending from the first end to the second end, the first end, the second end, and the side defining a cavity, the second end configured to receive and retain water within the cavity, the side comprises at least one opening that provides access to the cavity, the housing being formed as one piece with one or more of the first end, the second end, or the side.

Clause 22. The bait station of clause 1, wherein the bait station is capable of assuming at least two configurations, a first configuration in which the housing functions to attract and kill insects and a second configuration in which the housing occupies less space than the first configuration and functions for storage and transport of the bait station.

Clause 23. A composition comprising: at least one sugar, wherein the sugar is selected from the group consisting of sucrose, glucose, fructose, galactose, dextrose, and lactose, or any combination thereof; and at least one toxin, wherein the toxin is selected from the group consisting of spinosad, neonicotinoid, carbamate, organophosphate, organochlorine, pyrethrum, pyrethrin, pyrethroid, chlofenapyr, ethiprole, sulfoxoflor, pyriproxyfen, and boric acid, or any combination thereof.

Clause 24. The composition of clause 23, wherein the at least one sugar is unrefined sugar.

Clause 25. The composition of clause 23, wherein the at least one sugar is sucrose.

Clause 26. The composition of clause 23, wherein the composition comprises sugar in an amount of about 0.003% to about 95%.

Clause 27. The composition of clause 23, wherein the at least one toxin is spinosad.

Clause 28. The composition of clause 23, wherein the composition comprises toxin in an amount of about 0.003% to about 95%.

Clause 29. The composition of clause 23, further comprising at least one attractant.

Clause 30. The composition of clause 29, wherein the at least one attractant is selected from the group consisting of a visual attractant and an olfactory attractant, or any combination thereof.

Clause 31. The composition of clause 29, wherein the at least one attractant is selected from the group consisting of carbon dioxide, sugar, warmth, and a volatile organic compound, or any combination thereof.

Clause 32. The composition of clause 29, wherein the at least one attractant is selected from the group consisting of pinene, linalool, methylsalicylate, myrcene, phenylacetaldehyde, benzaldehyde, 1-hexanol, and phenylacetaldehyde, or any combination thereof.

Clause 33. The composition of clause 23, further comprising at least one synergist.

Clause 34. The composition of clause 33, wherein the synergist is selected from the group consisting of perilla oil and a perillaldehyde analog.

Clause 35. The composition of clause 23, further comprising at least one carrier, wherein the carrier is selected from the group consisting of mineral oil, glycerol, water, alcohol, petroleum distillate, acid, and ester, or any combination thereof.

Clause 36. The composition of clause 23, wherein the composition is substantially free of an insecticide synergist, wherein the insecticide synergist is selected from the group consisting of piperonyl butoxide (PBO), N-octyl bicycloheptene dicarboximide (MGK-264), piprotal, propyl isome, sesamex, sesamolin, and sulfoxide.

Clause 37. The bait station of clause 1, wherein the composition is according to any one of clauses 23-36.

Clause 38. A composition comprising: 8%-15% sucrose; 0.003%-1.0% spinosad; 0.0625%-0.5% linalool; 0.0938%-0.75% 1-hexanol; and 0.2188%-1.75% phenylacetaldehyde.

Clause 39. The bait station of clause 1, wherein the composition is the composition of clause 38.

Clause 40. A method for manufacturing a bait station, the method comprising: providing a housing that comprises a flexible portion; applying a composition to the housing, the composition comprising at least one sugar and at least one toxin; providing an insert; placing at least one olfactory attractant in the insert; and coupling the insert to the housing.

Clause 41. The method of clause 40, wherein the insert is a first insert and the method further comprises coupling a second insert to the housing, the second insert configured to adsorb moisture.

Clause 42. The method of clause 40, further comprising providing a visual attractant, the visual attractant making up at least a portion of the housing.

Clause 43. The method of clause 40, wherein applying the composition to the housing comprises spraying the housing with a liquid form of the composition.

Clause 44. The method of clause 40, wherein applying the composition to the housing comprises impregnating a material of the housing with a liquid form of the composition.

Clause 45. The method of clause 40, wherein applying the composition to the housing comprises submerging the housing into a liquid form of the composition, the housing configured to soak up the composition.

Clause 46. The method of clause 40, wherein providing the housing comprises coupling at least three panels to one another to define an opening, each of the at least three panels including a first side and a second side, the first side defining a portion of the exterior surface of the housing and the second side defining a portion of an interior surface of the housing.

Clause 47. The method of clause 46, wherein the insert is a first insert and the method further comprises coupling a second insert between the first side and the second side of at least one of the at least three panels, the second insert configured to adsorb moisture.

Clause 48. The method of clause 46, where coupling the first insert to the housing comprises coupling the first insert between the first side and the second side of at least one of the at least three panels.

Clause 49. The method of clause 40, wherein the composition is according to any one of clauses 23-36.

Clause 50. The method of clause 40, wherein the composition is the composition of clause 38.

Clause 51. A method for controlling insects, the method comprising applying an effective amount of the composition of at least one of clauses 23-36 to a bait station, and exposing a population to the bait station.

Clause 52. The method of clause 51, wherein the insect is a mosquito.

Clause 53. The method of clause 51, wherein applying the effective amount of the composition of at least one of clauses 23-36 to the bait station, comprises exposing the population to the composition so that the composition is ingested by the insects sufficient to kill at least 10% of the population.

Clause 54. The method of clause 53, wherein applying the effective amount of the composition of at least one of clauses 23-36 to the bait station, comprises exposing the population to the composition so that the composition is ingested by the insects sufficient to kill at least 15% of the population.

Clause 55. The method of clause 53, wherein applying the effective amount of the composition of at least one of clauses 23-36 to the bait station, comprises exposing the population to the composition so that the composition is ingested by the insects sufficient to kill at least 25% of the population.

Various features and advantages of the invention are set forth in the following claims.

1. A bait station comprising:
a housing that comprises a flexible portion;
a composition contained on or in the housing, the composition comprising at least one sugar and at least one toxin;
an insert coupled to the housing; and
at least one olfactory attractant contained in the insert.

2. The bait station of claim 1, wherein the insert is a first insert and the bait station further comprises a second insert coupled to the housing, the second insert configured to adsorb moisture.

3. The bait station of claim 2, wherein the second insert comprises silica beads, a superabsorbent material, or a combination thereof.

4. The bait station of claim 1, further comprising a visual attractant on an exterior surface of the housing.

5. The bait station of claim 4, wherein the visual attractant is black color.

6. The bait station of claim 1, wherein the housing comprises at least three panels, the panels coupled to one another and defining an opening.

7. The bait station of claim 6, wherein each of the at least three panels comprises a first side and a second side, the first side defining a portion of the exterior surface of the housing and the second side defining a portion of an interior surface of the housing.

8. (canceled)

9. The bait station of claim 7, further comprising a visual attractant on at least one of the first sides of the at least three panels.

10. The bait station of claim 7, further comprising a visual attractant on each of the first sides of the at least three panels.

11. The bait station of claim 7, wherein one of the at least three panels is a dark color on both the first side and the second side.

12. The bait station of claim 7, wherein the insert is a first insert and the bait station further comprises a second insert that is positioned between the first side and the second side of at least one of the at least three panels, the second insert configured to adsorb moisture.

13. The bait station of claim 7, wherein a conduit is positioned and extends between the first side and the second side of at least one of the at least three panels, the conduit configured to receive the insert.

14. (canceled)

15. The bait station of claim 4, wherein the visual attractant is one of a color or a pattern.

16-17. (canceled)

18. The bait station of claim 1, wherein the olfactory attractant comprises a volatile organic compound.

19. The bait station of claim 1, wherein the olfactory attractant is selected from the group consisting of pinene, linalool, methylsalicylate, myrcene, phenylacetaldehyde, benzaldehyde, 1-hexanol, and phenylacetaldehyde, or any combination thereof.

20-21. (canceled)

22. The bait station of claim 1, wherein the bait station is capable of assuming at least two configurations, a first configuration in which the housing functions to attract and kill insects and a second configuration in which the housing occupies less space than the first configuration and functions for storage and transport of the bait station.

23-37. (canceled)

38. A composition comprising:
8%-90% sucrose, and
0.003%-1.0% spinosad.

39. The bait station of claim 1, wherein the composition comprises
8%-90% sucrose, and
0.003%-1.0% spinosad.

40-50. (canceled)

51. A method for controlling insects, the method comprising exposing a population to the bait station of claim 1.

52. The method of claim 51, wherein the insect is a mosquito.

53-55. (canceled)

56. The composition of claim 38, further comprising:
0.01%-2.0% linalool;
0.01%-3.0% 1-hexanol; and
0.005%-7.0% phenylacetaldehyde.

57. The bait station of claim 39, wherein the at least one olfactory attractant comprises:
0.01%-2.0% linalool;
0.01%-3.0% 1-hexanol; and
0.005%-7.0% phenylacetaldehyde.
